(19) United States
(12) Patent Application Publication
(10) Pub. No.: US 2026/0254962 A1
(43) Pub. Date: Aug. 27, 2026

(54) CROSS-PLATFORM NEURAL CODECS USING TRANSMITTED ENTROPY DISTRIBUTION PARAMETERS

(71) Applicant: Microsoft Technology Licensing, LLC, Redmond, WA (US)

(72) Inventors: Tanel PÄRNAMAA, Tallinn (EE); Evgenii INDENBOM, Tallinn (EE); Martin LUMISTE, Tallinn (EE); Ardi LOOT, Tallinn (EE); Ando SAABAS, Tallinn (EE)

(73) Assignee: Microsoft Technology Licensing, LLC, Redmond, WA (US)

(21) Appl. No.: 19/063,070

(22) Filed: Feb. 25, 2025

(51) Int. Cl. H04N 19/13; H04N 19/124; H04N 19/154; H04N 19/196

(52) U.S. Cl. CPC H04N 19/13; H04N 19/124; H04N 19/154; H04N 19/198

(57) ABSTRACT

Cross-platform neural network codecs implemented using transmitted entropy distribution parameters are disclosed. In some examples, a neural network codec system is implemented with a first platform used to encode digital media, such as image, video, or other media that is different than a second platform used to decode the digital media. Some of the entropy distribution parameters used to decode the digital media are losslessly coded. In some examples of the disclosed technology, decoding digital media having encoded latents and hyperlatents includes producing entropy distribution parameters from hyperlatents decoded from the digital media that are shared by at least two groups of latents encoded in the digital media and used to decode latents encoded in the digital media.

### BACKGROUND

Compression decreases the cost of storing and transmitting information by converting the information into a lower bit rate form. Decompression (also called decoding) reconstructs a version of the original information from the compressed form. Application of compression techniques for image and video data is of interest due to the relatively large amount of storage and network bandwidth consumed by such data. A “codec” is an encoder/decoder system. Video and image encoder-decoder (“codec”) systems have become highly optimized over the past 35 years. Typically, a video or image codec implements complicated algorithms for compression and decompression, using a wide range of tools.

Over the past several decades, various video codec standards have been adopted, including the ITU-T H.261, H.262 (MPEG-2 or ISO/IEC 13818-2), H.263, H.264 (MPEG-4 AVC or ISO/IEC 14496-10), H.265/HEVC, H.266/VVC (ISO/IEC 23090-3 or MPEG-I Part 3) standards, the MPEG-1 (ISO/IEC 11172-2) and MPEG-4 Visual (ISO/IEC 14496-2) standards, and the SMPTE 421M (VC-1) standard. Such a video codec standard typically defines options for the syntax of an encoded video bitstream, detailing parameters in the bitstream when particular features are used in encoding and decoding. In many cases, a video codec standard also provides details about the decoding operations a video decoder should perform to achieve conforming results in decoding. Aside from codec standards, various proprietary codec formats define other options for the syntax of an encoded video bitstream and corresponding decoding operations.

A video encoder for a codec standard or proprietary format can provide very good quality for a given bitrate of encoded data. Even so, some information is typically lost during the compression process, especially if higher compression ratios are desired.

More recently, some video and image codecs use neural networks and other machine learning methods for data compression. For example, neural image codecs have been developed to compress/decompress images. These models use non-linear transforms in the encoder and decoder, as opposed to linear transforms used in classical codecs. Neural image codecs may use more sophisticated entropy models, where one or more or all components are optimized end-to-end using a rate-distortion objective. Based on similar concepts, neural video codecs have been developed to compress/decompress video frames. Despite the recent success of neural image and video codecs compared to conventional video compression/decompression technologies, ample room for improvement exists for increasing the compression quality and/or efficiency.

Video and image encoding and decoding can be used in various contexts, including online streaming and conferencing. A conferencing tool can process streams of audio content, streams of video content, graphic images, series of text messages, and other types of content. Of the different types of content, video content typically consumes the most bandwidth. In some cases, the quality of video content suffers during conferencing due to network congestion, which can cause issues such as delays in delivery or drops of packets of encoded data. In other cases, due to limitations on available network bandwidth, video content is preemptively encoded at low quality during conferencing. Compared to packets of encoded data for high-quality video, packets of encoded data for the low-quality video consume less bandwidth and are more likely to be delivered in a timely manner. On the other hand, low-quality video can exhibit extensive compression artifacts due to aggressive lossy compression.

### SUMMARY

Cross-platform neural network codecs implemented using transmitted entropy distribution parameters are disclosed. Certain aspects of the disclosed technology can be used in combination or separately.

In some examples, a computer-implemented method of decoding digital media having encoded latents includes producing, from the digital media, entropy distribution parameters for decoding the digital media using an adaptive entropy model, at least one of the entropy distribution parameters having been losslessly encoded in the digital media and decoding the encoded latents from the digital media using at least one of the losslessly encoded entropy distribution parameters. In some examples, the adaptive entropy model includes an entropy distribution modeled as an adaptive Gaussian distribution having mean and scale parameters; and at least one of the losslessly encoded entropy distribution parameters is a scale parameter.

In some examples, a neural network codec system is implemented with a first platform used to encode digital media, such as image, video, or other media that is different than a second platform used to decode the digital media. Some of the entropy parameters used to decode the digital media can be transmitted as hyperlatents shared in decoding multiple latents in the digital media. For example, the two platforms may have different processors, co-processor, software versions, inference engines, or other differences, which, when processing digital media, cause differences in the representation of latents, hyperlatents, or machine learning model parameters or outputs such that the decoded digital media is distorted, unretrievable, or lost. Even small differences in such a representation can cause such errors.

In some examples of the disclosed technology, a computer-implemented method of decoding digital media having encoded latents and hyperlatents includes using a processor to produce scales from hyperlatents decoded from the digital media, at least one of the scales being shared by at least two groups of latents encoded in the digital media, produce predicted mean values from decoded latents using a machine learning model, and decode entropy-coded latents from the digital media based on the produced scales and the predicted mean values.

In some examples, the method of decoding further includes decoding the hyperlatents from encoded digital media, the encoded digital media comprising plural data channels and producing combined quantized latents for reconstructing digital media based on the decoded entropy-coded latents. The producing the scales is performed by slicing and expanding the decoded hyperlatents, the decoded hyperlatents having plural channels, at least one of the scales being shared by at least two groups of latents encoded in the digital media. In some examples, the producing predicted mean values includes producing first mean values from the decoded hyperlatents using a first machine learning model, producing first quantized latents by shifting the decoded latents according to the first mean values, producing second mean values from the first mean values using a second neural network, producing second quantized latents by shifting the decoded latent values according to the second mean values, and the decoding the entropy-coded latents includes producing combined quantized latents using the first quantized latents and the second quantized latents.

In some examples, a method of encoding digital media includes producing the latents by encoding the digital media with a neural network encoder, generating hyperlatents, which also include scale values from the latents, quantizing the hyperlatents, encoding the quantized hyperlatents, and sending the quantized hyperlatents to the decoder via a computer-readable media. A processor used to perform the encoding the digital media may produce different entropy parameters than the processor decoding the digital media due to differences in floating point arithmetic or numerical representations for machine learning models used in encoding or decoding the digital media, respectively. In some examples, the encoded digital media is stored in a computer-readable storage medium. In some examples, the encoded digital media is transmitted via a computer-readable medium, such as over a computer network.

In some examples, computer-readable storage media store computer-executable instructions, which when executed by a processor, cause the processor to perform a method of decoding images or video with a machine learning tool according to methods disclosed herein. In some examples, a system comprises the computer-readable storage media, a processor, a network interface to transmit bitstreams comprising quantized latents and hyperlatents, and a display interface to cause a display to display video or images encoded in the received bitstream. In some examples, a method of training neural networks is performed to produce a machine learning model used to encode or decode digital media.

This Summary is provided to introduce a selection of concepts in a simplified form that are further described below in the Detailed Description. This Summary is not intended to identify key aspects or essential features of the claimed subject matter, nor is it intended to be used to limit the scope of the claimed subject matter. The foregoing and other objects, aspects, and advantages of the disclosed subject matter will become more apparent from the following detailed description, which proceeds with reference to the accompanying figures.

### BRIEF DESCRIPTION OF THE DRAWINGS

FIG. 1 depicts an example network environment using an encoder and decoder for bidirectional, real-time communication, as can be implemented in some examples of the disclosed technology.

FIG. 2 depicts an example network environment using an encoder with multiple playback tools having decoders, as can be implemented in some examples of the disclosed technology.

FIGS. 3A-3B depict an example neural codec system in conjunction with which some described examples may be implemented.

FIGS. 4A-4B depict an example neural video codec system in conjunction with which some described examples may be implemented.

FIG. 5 depicts a flow chart outlining an example method of decoding digital media using losslessly encoded entropy distribution parameters.

FIG. 6 depicts a flow chart outlining an example method of decoding digital image media using a neural image decoder, as can be performed in certain examples of the disclosed technology.

FIG. 7A-7B depict a flow chart outlining an example method of encoding digital image media using a neural image decoder, as can be performed in certain examples of the disclosed technology.

FIG. 8 depicts a flow chart outlining an example method of training neural networks for implementing encoders and decoders, as can be performed in some examples of the disclosed technology.

FIG. 9 illustrates a generalized example of a suitable computer system in which several of the described innovations may be implemented.

### DETAILED DESCRIPTION

### I. Overview

Codecs commonly include a number of components, including: an analysis transform in the encoder that converts the data into a latent space, a quantizer to map the latents into discrete values, a synthesis transform in the decoder to convert from the latent space back into the source data space, and an entropy model that represents the probability distribution of latents. One aspect of neural codec technologies is to improve compression performance by using neural networks in these components and optimizing the components end-to-end using a data-driven approach.

Many neural codec technologies focus on designing an entropy model to predict the probability distribution of a quantized latent representation of an image, e.g., by using a factorized model, a hyper prior, an auto-regressive prior, a mixture Gaussian model, a transformer-based model, etc. Recently, the compression ratio of neural codecs has been shown to outperform more traditional image codec technologies such as JPEG or BPG, as well as video codec technologies such as H.264, H.265, and H.266. However, neural network-based image and video codecs are not widely used in practice. One of the main reasons is the cross-platform consistency issue. When a sender and receiver use different software or hardware platforms, even small differences in floating point arithmetic lead to slightly different entropy distribution parameters, which can cause the decoding of a bitstream to fail catastrophically.

Specifically, many multimedia codecs use entropy coding (arithmetic coding or variants of it) to encode transformed data into a bitstream. Entropy coding depends on a probability model, and for state-of-the-art codecs, this probability model is adaptive: a neural network predicts entropy model distribution parameters, such as means and scales for a discretized Gaussian distribution. When these parameters differ even slightly, the decoding fails catastrophically.

A common approach to addressing the cross-platform issue is to quantize the neural networks related to distribution parameters and run model inference using integer arithmetic. However, quantizing the model usually results in a significant loss in codec quality, and it requires substantial engineering work to reduce the quality gap. Moreover, not all platforms support the required data types. Additionally, not all software packages implement neural network building blocks, such as activation functions, identically, and a quantized model can still lead to catastrophic decoding failures.

To ensure these entropy model distribution parameters are identical between the encoding and decoding side, certain disclosed implementations send these parameters in an auxiliary bitstream. A naive implementation would considerably increase the bitstream size because there could be more entropy distribution parameters than the size of the encoded data. To avoid significantly increasing the bitstream size, the parameters can be shared over spatial locations, channels, or a combination of spatial locations and channels, and entropy coded with a non-adaptive entropy model. Such an approach can lend itself to simpler implementation that use fewer resources while preserving model quality well enough to outperform traditional codecs.

While image and video codecs are explained in greater detail herein, it will be readily apparent to a person of ordinary skill in the art, having the benefit of the present disclosure, to apply certain disclosed techniques to other modalities of codecs, for example, audio codecs, text codecs, speech codecs, two- or three-dimensional graphics and geometry codecs, and sensor or scientific data codecs.

### II. Example Network Environments for Real-Time Communication and Playback

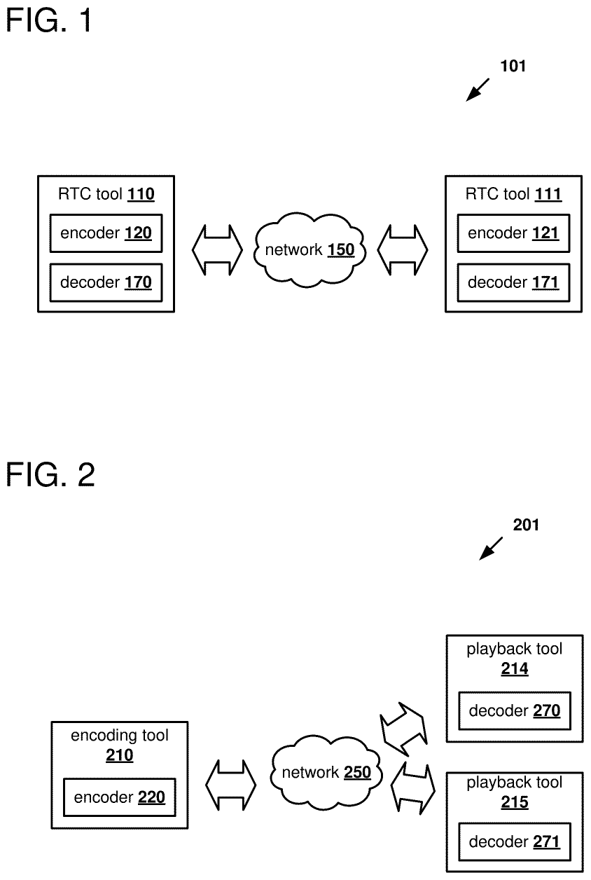

FIGS. 1 and 2 show example network environments (101, 201) that include encoders (120, 121, 220) and decoders (170, 171, 270, 271). The encoders and decoders are connected over a communication network (150, 250) using an appropriate communication protocol. The communication network can include the Internet or another computer network. The encoders and decoders may encode images, video, or other suitable modalities of data.

In the network environment (101) shown in FIG. 1, each real-time communication (“RTC”) tool (110/111) includes both an encoder (120/121) and a decoder (170/171) for bidirectional communication. A given encoder can output encoded data as part of a bitstream, with a corresponding decoder accepting the encoded data from the encoder (120). The bidirectional communication can be part of a video conference, video telephone call, or other two-party or multi-party communication scenario. Although the network environment (101) in FIG. 1 includes two real-time communication tools (110, 111), the network environment (101) can instead include three or more real-time communication tools that participate in multi-party communication.

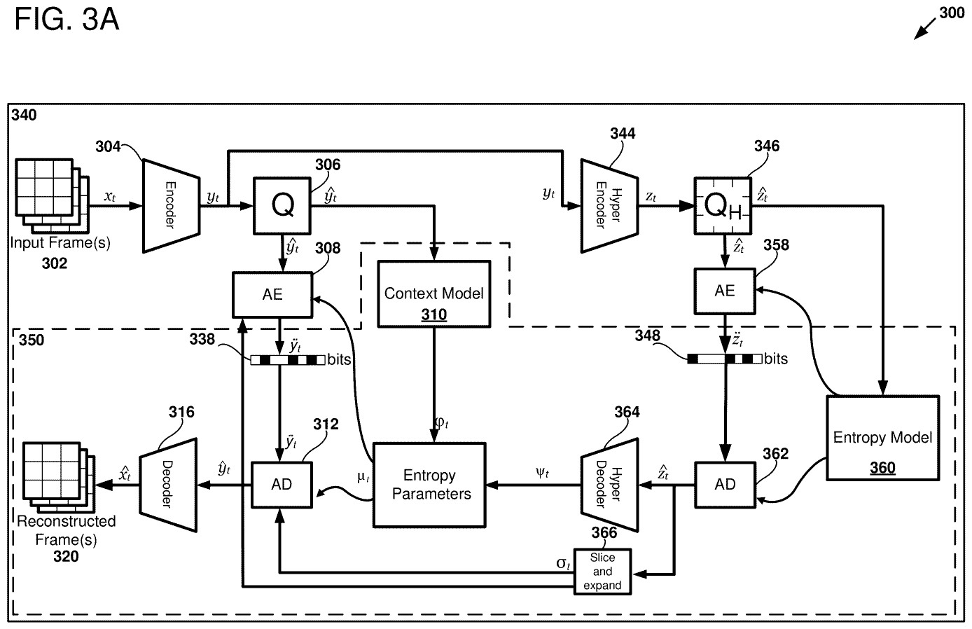

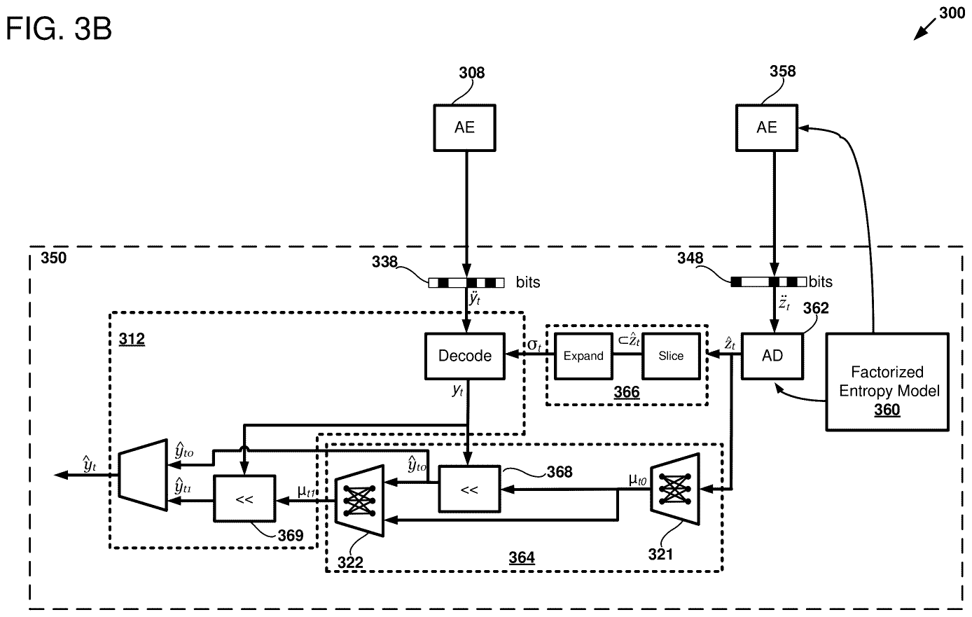

A real-time communication tool (110) manages encoding by an encoder (120). FIGS. 3A-3B show an example encoder (340) that can be included in the real-time communication tool (210). A real-time communication tool (210) also manages decoding by a decoder (270). FIGS. 3A-3B also shows an example decoder (350) that can be included in the real-time communication tool (210).

In the network environment (201) shown in FIG. 2, an encoding tool (210) includes an encoder (220) that encodes video for delivery to multiple playback tools (214, 215), which include decoders (270, 271). The unidirectional communication can be provided for a video surveillance system, web camera monitoring system, remote desktop conferencing presentation or sharing, wireless screen casting, cloud computing or gaming, or other scenario in which video is encoded and sent from one location to one or more other locations. Although the network environment (201) in FIG. 2B includes two playback tools (214, 215), the network environment (201) can include more or fewer playback tools. In general, a playback tool (214 or 215) communicates with the encoding tool (210) to determine a stream of video for the playback tool (214/215) to receive. The respective playback tool receives the stream, buffers the received encoded data for an appropriate period, and begins decoding and playback.

FIGS. 3A-3B shows an example encoder (340) that can be included in the encoding tool (210). The encoding tool (210) can also include server-side controller logic for managing connections with one or more playback tools (214). A playback tool (214) can include client-side controller logic for managing connections with the encoding tool (210). FIGS. 3A-3B also show an example decoder (350) that can be included in the playback tool (214).

### III. Example Neural Codec System

FIGS. 3A-3B show an example neural codec system (300) in conjunction with which some described examples may be implemented. The neural codec system (300) is depicted as a high-level diagram FIG. 3A and a further detailed portion of the system is depicted in the diagram of FIG. 3B, which shows additional details of the decoding process performed in certain examples of the disclosed technology. The example neural codec system (300) can be adapted to compress images, or independent frames of video. As shown, the neural codec system (300) includes a neural image encoder (340) configured to encode video frames into encoded data using at least one transmitted entropy parameter. The neural image encoder (340) that can be an embodiment of the encoder (220) depicted in FIGS. 2A-2B. The neural codec system (300) also includes a neural image decoder (350, indicated by dashed lines) configured to reconstruct the video frames from the encoded data using the hybrid entropy model. The neural image decoder (350) can be an embodiment of the decoders (e.g., decoders 170, 171, 270, or 271) depicted in FIGS. 1 and 2A-2B. As shown, the neural image encoder (340) can comprise the neural image decoder (350). In certain examples, the neural image decoder (350) can be a standalone system.

The neural codec system (300) or portions of the neural codec system (300), such as the neural image encoder (340) and/or the neural image decoder (350), can be implemented as part of an operating system module, as part of an application library, as part of a standalone application, or using special-purpose hardware. Overall, the neural image encoder (340) receives a sequence of source image frames (302) from a video source (e.g., a camera, tuner card, storage media, screen capture module, or other digital video source) and produces encoded data as output as a bitstream to a computer-readable media (338). The encoded data output to the computer-readable media (338) can include content encoded using one or more of the innovations described herein. The neural image decoder (350) receives encoded data from the computer-readable media (338) and produces reconstructed video frames (320) as output for an output destination (e.g., video display devices, storage media, etc.). As used herein, the term “frame” generally refers to source, coded or reconstructed image data. The computer-readable media (338) can be implemented using transitory media, such as a transmitted signal via radio or a computer network, alone or in combination with non-transitory computer-readable storage media, such as computer-readable storage devices.

The received encoded data can include content encoded using one or more of the innovations described herein. In some examples, singular images can be encoded and decoded according to disclosed techniques, instead of or in addition to video. For ease of explanation, certain examples disclosed herein are described in the context of a single frame, although, as will be understood to a person of ordinary skill in the relevant art having the benefit of the present disclosure, the innovations disclosed herein can be extended to use motion encoding to share data between multiple frames in a sequence.

The neural image encoder (340) receives a current image frame (302), encodes the current image frame to produce encoded data, and output the encoded data as part of a bitstream transmitted via computer-readable media (338) to a decoder. As discussed further below, hyperlatents generated from the current image frame (302) are encoded as part of a bitstream transmitted via computer-readable media 348. In some examples, the bitstreams are transmitted via separate media (338, 348). In other examples, the encoded data and hyperdata is transmitted a single media (in other words, the latent bitstream and the hyperlatent bitstream is transmitted via the same computer-readable media). The neural image decoder (350) can receive encoded data as part of a bitstream, decode the encoded data to reconstruct the current video frame, and output the reconstructed current video frame (320). Moreover, the neural image encoder (340) includes components of the decoder (350) so that entropy parameters can be used in the encoding process. As part of the decoding, the neural image decoder (350) uses one or more aspects of a hyperencoder as described herein. In this example, the current image frame (302) is denoted as xₜ, where t is the frame index, and the reconstructed current image frame (320) is denoted as \hat{x}ₜ.

### A. Example Encoding and Decoding

An encoder (304) can be configured to generate a current latent representation yₜ for the current video frame xₜ as described herein, elements of the current latent representation yₜ are logically organized in three dimensions, including two spatial dimensions (corresponding to height and width of the current video frame xₜ) and one channel dimension. The encoder (304) includes one or more convolutional layers.

To achieve bitrate saving, the current latent representation yₜ is quantized to a quantized latent representation ŷₜ by a quantizer (306) before being sent to an arithmetic encoder (“AE” 308) which generates a bitstream containing the data of the quantized latent representation ýₜ. Typically, the quantizer (306) converts the latent values (or simply “latents”) from a floating-point or fixed-point representation to an integer representation. The quantizer (306) may also round, truncate, or perform other operations to quantize the data. In some examples, the latent values are mapped uniformly to the quantized latent values, while in others, certain ranges of latents can be mapped non-uniformly.

In some examples, in addition to statistical characteristics, the entropy context model network (310) can generate a plurality of per-area quantization step values, global quantization step values, and/or multiple per-channel quantization step values for different channels. Using one or more of these step values, the quantizer (306) can perform multi-granularity quantization and inverse quantization, respectively, as described more fully below.

During the decoding, the quantized latent representation ŷₜ is decoded from the bitstream ÿₜ, by an arithmetic decoder (“AD” 312). To encode and decode the quantized latent representation ŷₜ, the entropy coder needs a prior probability distribution over the quantized latents. The prior probability distribution can be learned using a machine learning tool such as a neural network. The prior probability model can be represented as a fully factorized distribution. In a factorized entropy model, it is assumed that each value of the representation ŷₜ is statistically independent of the other values of the tensor, which avoids added complexity of modeling dependencies between latent values.

To achieve more efficient compression, the prior probability model can be made adaptive. For example, side information is encoded and sent in an auxiliary bitstream to adapt the probability model that is used to encode and decode the quantized latent representation ŷₜ. An adaptive entropy model is a computer-implemented entropy encoding method used in lossless data compression. In some examples, a computer implementing an adaptive entropy model can adapt to localized changes in the characteristics of the data, allowing for compression without requiring a first pass over the data to calculate a probability model, which can improve compression efficiency. In certain examples, the adaptive entropy model uses entropy distribution parameters that define a probability distribution used to encode the data. In some examples, the probability distribution is an adaptive discretized Gaussian distribution using scale parameters and mean parameters. In some examples, a probability distribution can include additional or different parameters. In some examples, other discrete probability distribution can be used, for example, a discretized Laplace distribution, a binomial distribution, a Poisson distribution, or other suitable discrete probability distribution for image encoding.

In some examples, a prior probability distribution can be made adaptive by providing a hierarchical prior probability. Then, the encoder (304) also sends the latents yₜ to a hyperencoder (344) to generate hyper prior zₜ, also called hyperlatent values or simply “hyperlatents.” The current hyper latent representation zₜ is quantized to a quantized hyper latent representation \hat{z}ₜ by a quantizer (346) before being sent to an entropy encoder, such as an arithmetic encoder (“AE”) (358) which generates a bitstream \ddot{z}ₜ (348) containing the data for the hyperlatent representation. In some examples, the prior probability model of the quantized hyperlatent representation \hat{z}ₜ can be a factorized entropy model (360). This side information is used to adapt the probability model that is used to encode and decode the quantized latent representation ŷₜ.

During the decoding, the bitstream \ddot{z}ₜ is decoded by an arithmetic decoder “AD” (362) to produce a decoded quantized current hyperlatent representation \hat{z}ₜ. In a classical hierarchical probability model setting, hyperdecoder (364) produces distribution parameter values for the probability distribution used to encode and decode ŷₜ. For example, the probability distribution of quantized latents ŷₜ can be modelled by a discretized Gaussian distribution, in which case the distribution parameters are the mean parameters u and scale parameters σ.

These entropy distribution parameters are used in the AE (308) and AD (312) to more efficiently encode and decode the quantized latent representation ŷₜ. The mean parameters μ can also be subtracted from the latents yₜ before quantization, and added back after quantized latents have been decoded from the bitstream ÿₜ.

To avoid catastrophic decoding failures, the probability distribution parameters should be identical between the encoding and decoding side. In the case of a discretized Gaussian distribution, where the latents have been zero-centered, the scale parameters should be identical. This can be achieved by sending the probability distribution parameters, such as scales, losslessly in an auxiliary bitstream. This can be done by utilizing the hyperlatents bitstream \ddot{z}ₜ. Specifically, after bitstream \ddot{z}ₜ is decoded by an arithmetic decoder “AD” (362) to produce a decoded quantized current hyperlatent representation \hat{z}ₜ, a subset of the hyperlatents is taken to represent probability distribution parameters, such as scales σ. The subset can be disjoint from the hyperlatents that are passed to the hyperdecoder (364) or these values can be shared. The scale parameters can be represented as indices in the hyperlatent representation. In this case, the index can represent a location in a lookup table of scales or can be mapped to a scale value using an exact mathematical formula. Then, these values can be expanded to the size of quantized latents ŷₜ by copying values. This is shown as a slice and expand module (366) in FIG. 3A.

In addition to making the prior probability model of the quantized latent representation ŷₜ hierarchical, better compression can be achieved by making it autoregressive, or in other words, using a spatial prior. Part of the quantized latent representation ŷₜ is encoded and decoded first with the AE (308) and AD (312) with the prior probability distribution parameters derived from the hyperlatents. For example, in the case of a discretized Gaussian distribution, the mean values come from the hyperdecoder (364) and the scale parameters from the Slice and expand module (366). Next, the context model (310) predicts new prior probability distribution parameters based on the quantized latent representation ŷₜ that have already been encoded. This can be combined by the hyper decoder output by using the entropy parameters module (315). The scale parameters can be identical to the values that were used for encoding the first part of the latents. This process can continue depending how many groups the quantized latents were split into.

A decoder (316) generates reconstructed frame \hat{x}ₜ from the decoded current latent representation ŷₜ.

A portion of the neural decoder (350) is depicted in the diagram of FIG. 3B in further detail. As shown, the scales are decoded from the bitstream received via computer-readable media (348) using an entropy decoder (in this example, the arithmetic decoder (362) to produce quantized hyperlatent values \hat{z}ₜ. The decoder (350) uses the slice and expand module (366) to select a slice of the quantized hyperlatent values \hat{z}ₜ which is a subset of the \hat{z}ₜ tensor that can be processed independently of other slices within the same frame t, as the encoding and decoding of values in the slice does not rely on other data of the tensor. In certain examples, the slice can be selected from a row, column, block, or other predetermined subset of the tensor. In some examples, the slice can be selected from a subset of channels of the quantized hyperlatent values \hat{z}ₜ, for example, by taking the first 64 of 128 channels present in the tensor. The slice values are then expanded to the same dimensions of the quantized latent (for example, expanded from 2×2×64 to 16×16×128). For example, the slice values can be expanded by copying the values to form a padded array of scales σ. In other examples, different slice and expand dimensions and techniques can be used.

The scales are then combined with the mean produced using the hyperdecoder (364). In some examples, mean values are predicted as follows. In the illustrated example, the hyperlatent values \hat{z}ₜ are provided to a machine learning model (321) (such as a convolutional neural network) to produce a tensor of first intermediate mean values μ₀. The latent values y decoded from the bitstream via the computer-readable media (338) are shifted according to the first set of intermediate mean values μ₀ (for example, by adding individual elements of tensor μ₀ to the corresponding tile of the latent values y using a shifter 368) to produce a first intermediate quantized latent ŷₜ₀. The first intermediate quantized latent ŷₜ₀ and the first set of intermediate mean values μ₀ are provided to a second machine learning model (322) (such as a convolutional neural network) to produce a tensor for a second set of intermediate mean values μ₁.

The latent values y decoded from the bitstream via the computer-readable media (338) are shifted according to the second set of intermediate mean values μ₁ (for example, by adding individual elements of tensor μ₁ to the corresponding tile of the latent values y using a shifter 369) to produce a second intermediate quantized latent ŷₜ₁.

The first intermediate quantized latent ŷₜ₀. second intermediate quantized latent ŷₜ₁. are combined to produce the decoded quantized latent values ŷₜ. As will be readily understood to a person of ordinary skill in the art having the benefit of the present disclosure, a number of different methods of combination can be used. For example, the intermediate quantized latents ŷₜ₀ and ŷₜ₁ can be combined by addition (with or without an additional weight), multiplication, concatenation, or other suitable methods. The decoded quantized latent values ŷₜ are provided to the decoder (316) to produce the reconstructed frame(s) \hat{x}ₜ.

### B. Example Tensor Sizes

Table 1 below shows an example of tensor size as can be used for the codec system of FIGS. 3A-3B. This table is provided to further detail the operation of the codec system, but as will be readily understood to a person of ordinary skill in the art having the benefit of the present disclosure, such systems are not limited to the specific resolution of the tensor dimensions shown in the table.

TABLE 1

| Symbol | Description | Tensor Size |
|---|---|---|
| x | input image | 256 × 256 × 3 |
| y | latents | 16 × 16 × 128 |
| ŷ | quantized latents | 16 × 16 × 128 |
| z | hyperlatents | 2 × 2 × 128 |
| \hat{z} | quantized hyperlatents | 2 × 2 × 128 |
| ⊂\hat{z} | subset of the quantized | 2 × 2 × 64 |
| | hyperlatents | |
| μ | predicted means | 16 × 16 × 128 |
| σ | predicted scales | 16 × 16 × 128 |
| \hat{x} | decoded latents for image | 256 × 256 × 3 |
| | reconstruction | |

### C. Extension of Encoding and Decoding Techniques to Multiple Frames

The encoder/decoder system described above regarding FIG. 3A-3B, encodes entropy parameters to regenerate compressed frames in the spatial domain. As will be readily understood to a person of ordinary skill in the art having the benefit of the present disclosure, the described system can be expanded across the temporal domain to encode entropy parameters across multiple frames for use in certain examples of video codec applications. For example, the reconstructed video frame \hat{x}ₜ can be stored in the frame and feature buffer and used by the motion estimator to produce a motion vector (MV) for a subsequent (or preceding) video frame. Additionally, the frame generator can also produce the current feature parameter set. The current feature parameter set can also be stored in the frame and feature buffer and used by an encoder (304), decoder (316), temporal context mining network of the entropy context model network (310) or any other part of the system to more efficiently compress subsequent video frames.

### IV. Example Neural Video Codec System

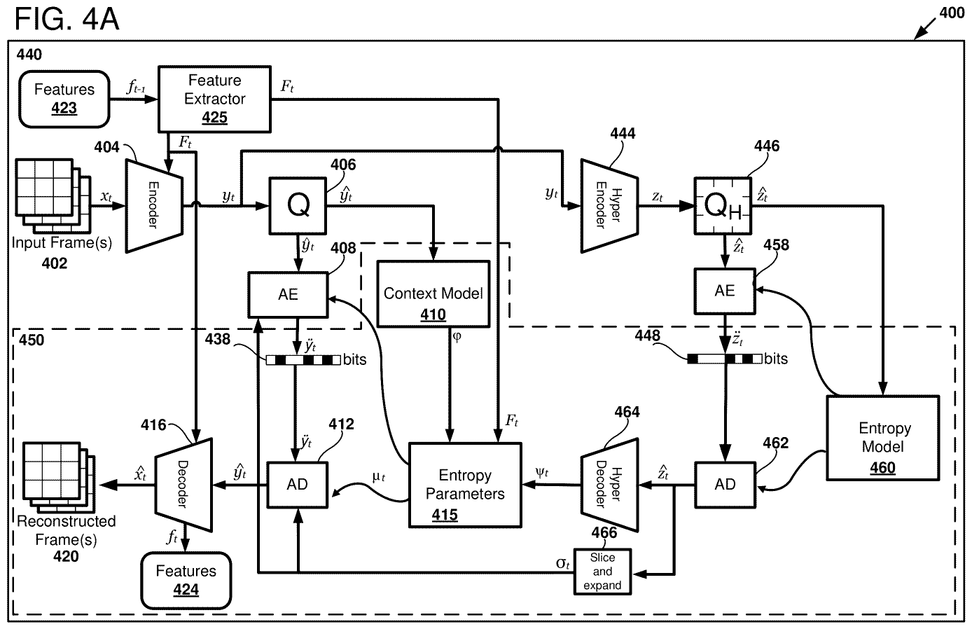

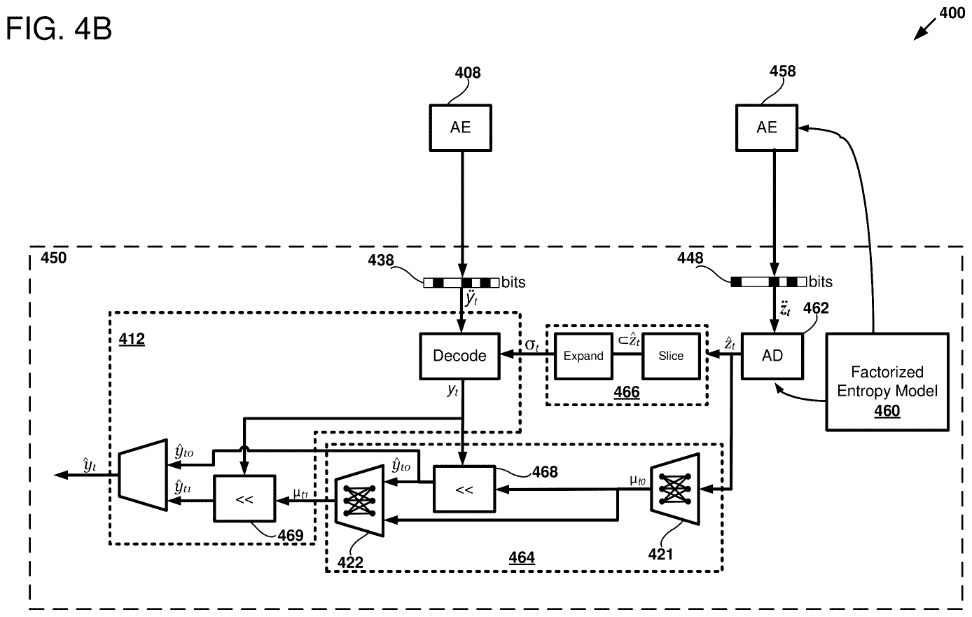

FIGS. 4A-4B show an example neural video codec system in conjunction with which some described examples may be implemented. The neural video codec system (400) is depicted as a high-level diagram FIG. 4A and a further detailed portion of the system is depicted in the diagram of FIG. 4B. showing additional details of the decoding process performed in certain examples of the disclosed technology. The neural video codec system includes a neural video encoder (440) configured to encode video frames into encoded data using a transmitted entropy parameters. The neural video encoder (440) that can be an embodiment of the encoder (220) depicted in FIGS. 2A-2B. The neural video codec system (400) also includes a neural video decoder (450, indicated by dashed lines) configured to reconstruct the video frames from the encoded data using the hybrid entropy model. The neural video decoder (450) can be an embodiment of the decoders (e.g., decoders 170, 171, 270, or 271) depicted in FIGS. 1 and 2A-2B. As shown, the neural video encoder (440) can comprise the neural video decoder (450). In certain examples, the neural video decoder (450) can be a standalone system.

The neural video codec system (400) or portions of the neural video codec system (400), such as the neural video encoder (440) and/or the neural video decoder (450), can be implemented as part of an operating system module, as part of an application library, as part of a standalone application, or using special-purpose hardware. Overall, the neural video encoder (440) receives a sequence of source video frames (402) from a video source (e.g., a camera, tuner card, storage media, screen capture module, or other digital video source) and produces encoded data as output as a bitstream to a computer-readable media connection (448). The encoded data output to the computer-readable media connection (448) can include content encoded using one or more of the innovations described herein. The neural video decoder (450) receives encoded data from the computer-readable media (448) and produces reconstructed video frames (420) as output for an output destination (e.g., video display devices, storage media, etc.). As used herein, the term “frame” generally refers to source, coded or reconstructed image data. The computer-readable media connection can be implemented using transitory media, such as a transmitted signal via radio or a computer network, alone or in combination with non-transitory computer-readable storage media, such as computer-readable storage devices.

The received encoded data can include content encoded using one or more of the innovations described herein. In some examples, singular images can be encoded and decoded according to disclosed techniques, instead of or in addition to video. For ease of explanation, certain examples disclosed herein are described in the context of a single frame, although, as will be understood to a person of ordinary skill in the relevant art having the benefit of the present disclosure, the innovations disclosed herein can be extended to use motion encoding to share data between multiple frames in a sequence.

The neural video encoder (440) receives a current video frame (402), encodes the current video frame to produce encoded data, and output the encoded data as part of a bitstream transmitted via computer-readable media (438) to a decoder. As discussed further below, hyperlatents generated from the current video frame (402) are encoded as part of a bitstream transmitted via computer-readable media (448). In some examples, the bitstreams are transmitted via separate media (438, 448). In other examples, the encoded data and hyperdata is transmitted a single media (in other words, the latent bitstream and the hyperlatent bitstream are transmitted via the same media). The neural video decoder (450) can receive encoded data as part of a bitstream, decode the encoded data to reconstruct the current video frame, and output the reconstructed current video frame (420). Moreover, the neural video encoder (440) includes components of the decoder (450) so that entropy parameters can be used in the encoding process. As part of the decoding, the neural video decoder (450) uses one or more aspects of a hyperencoder as described herein. In this example, the current video frame (402) is denoted as xₜ, where t is the frame index, and the reconstructed current video frame (420) is denoted as \hat{x}ₜ. At least some entropy distribution parameters can be losslessly encoded in the computer-readable media (448).

A contextual encoder (404) can be configured to generate a current latent representation yₜ for the current video frame xₜ as described herein, elements of the current latent representation yₜ are logically organized in three dimensions, including two spatial dimensions (corresponding to height and width of the current video frame xₜ) and one channel dimension. The contextual encoder (404) includes one or more convolutional layers, and takes as inputs the current frame xₜ and context Fₜ. The context Fₜ is extracted from previously decoded feature fₜ₋₁ (423) using one or more convolutional layers with a feature extractor (425). As will be readily understood to a person of ordinary skill in the art having the benefit of the present disclosure, a number of different decoded features, or combinations of the features, can be used to decode the feature using one or more convolutional layers of a neural network. For example, motion compensation, temporal correlation, spatial correlation, attention mechanisms, or other suitable techniques can be employed to decode features that are used to generate context.

To achieve bitrate saving, the current latent representation y is quantized to a quantized latent representation ŷₜ, by a quantizer (406) before being sent to an arithmetic encoder (“AE” 408) which generates a bitstream ÿₜ containing the data of the quantized latent representation ŷₜ. Typically, the quantizer (406) converts the latent values (or simply “latents”) from a floating-point or fixed-point representation to an integer representation. The quantizer (406) may also round, truncate, or perform other operations to quantize the data. In some examples, the latent values are mapped uniformly to the quantized latent values, while in others, certain ranges of latents can be mapped non-uniformly.

In some examples, in addition to statistical characteristics, the entropy context model network (410) can generate a plurality of per-area quantization step values, global quantization step values, and/or multiple per-channel quantization step values for different channels. Using one or more of these step values, the quantizer (406) can perform multi-granularity quantization and inverse quantization, respectively, as described more fully below.

The bitstream ÿₜ is generated by a lossless entropy coder, for example, an arithmetic encoder (“AE” 408). During the decoding, the quantized latent representation ŷₜ is decoded from the bitstream ÿₜ by an arithmetic decoder (“AD” 412). To encode and decode the quantized latent representation ŷₜ, the entropy coder needs a prior probability distribution over the quantized latents. The prior probability distribution can be learned using a machine learning tool such as a neural network. The prior probability model can be represented as a fully factorized distribution. In a factorized entropy model, it is assumed that each value of the representation ŷₜ is statistically independent of the other values of the tensor, which avoids added complexity of modeling dependencies between latent values.

The prior probability model can be made hierarchical to achieve more efficient compression. Then, the encoder (404) also sends the latents yr to a hyperencoder (444) to generate hyper prior zₜ, also called hyperlatent values or simply “hyperlatents.” The current hyper latent representation zₜ is quantized to a quantized hyper latent representation \hat{z}ₜ by a quantizer (446) before being sent to an entropy encoder, such as an arithmetic encoder (“AE”) (458) which generates a bitstream \ddot{z}ₜ (448) containing the data for the hyperlatent representation. The prior probability model of the quantized hyperlatent representation \hat{z}ₜ can be a factorized entropy model (460). This side information is used to adapt the probability model that is used to encode and decode the quantized latent representation ŷₜ.

During the decoding, the bit-steam \ddot{z}ₜ is decoded by an arithmetic decoder “AD” (462) to produce a decoded quantized current hyperlatent representation \hat{z}ₜ. In a classical hierarchical probability model setting, hyperdecoder (464) produces distribution parameter values for the probability distribution used to encode and decode ŷₜ. For example, the probability distribution of quantized latents ŷₜ can be modelled by a discretized Gaussian distribution in which case the distribution parameters are the mean parameters μ and scale parameters σ. In some examples, a probability distribution can include additional or different parameters. In some examples, a predefined discrete probability distribution can be used, for example, a discretized Laplace distribution or an exponential distribution, a binomial distribution, a Poisson distribution, or other suitable discrete probability distribution for image encoding.

These entropy distribution parameters are used in the AE (408) and AD (412) to more efficiently encode and decode the quantized latent representation ŷₜ. The means μ can also be subtracted from the latents yₜ before quantization, and added back after quantized latents have been decoded from the bitstream ÿₜ.

To avoid catastrophic decoding failures, the probability distribution parameters need to be identical between the encoding and decoding side. In the case of discretized Gaussian distribution where the latents have been zero-centered, the scale parameters need to be identical. This is achieved by sending the probability distribution parameters, such as scales, in an auxiliary bitstream. This can be done by utilizing the hyperlatent bitstream \ddot{z}ₜ. Specifically, after bit-steam \ddot{z}ₜ is decoded by an arithmetic decoder “AD” (462) to produce a decoded quantized current hyperlatent representation \hat{z}ₜ, a subset of the hyperlatents is taken to represent probability distribution parameters, such as scales σ. The subset can be disjoint from the hyperlatents that are passed to the hyperdecoder (464) or these values can be shared. Then, these values can be expanded to the size of quantized latents ŷₜ by copying values. This is shown as slice and expand module (466) in FIG. 4A.

In addition to making the prior probability model of the quantized latent representation ŷₜ hierarchical, better compression can be achieved by making it autoregressive, or in other words, using a spatial prior. Part of the quantized latent representation ýₜ is encoded and decoded first with the AE (408) and AD (412) with the prior probability distribution parameters derived from the hyperlatents. For example, in the case of a discretized Gaussian distribution, the mean values come from the hyperdecoder (464) and the scale parameters from the Slice and expand module (466). Next, the Context model (410) predicts new prior probability distribution parameters based on the quantized latent representation ŷₜ that have already been encoded. This can be combined by the hyper decoder output by using the Entropy Parameters module (415). The scale parameters can be identical to the values that were used for encoding the first part of the latents. This process can continue depending on how many parts the quantized latents were split.

Moreover, temporal information can be used to make the prior probability model more accurate. In this case, the Entropy Parameters module (415) uses features extracted from the feature extractor (425) as an additional input.

Finally, a contextual decoder (416) generates reconstructed frame \hat{x}ₜ from the decoded current latent representation ŷₜ and context Fₜ. It also produces features fₜ (424) that can be used to contextually encode the next frame.

A portion of the neural video decoder (450) is depicted in the diagram of FIG. 4B. As shown, the scales are decoded from the bitstream received via computer-readable media (448) using an entropy decoder (in this example, the arithmetic decoder (462) to produce quantized hyperlatent values \hat{z}ₜ. The decoder (450) uses the slice and expand module (466) to select a slice of the quantized hyperlatent values \hat{z}ₜ which is a subset of the \hat{z}ₜ tensor that can be processed independently of other slices within the same frame t, as the encoding and decoding of values in the slice does not rely on other data of the tensor. In certain examples, the slice can be selected from a row, column, block, or other predetermined subset of the tensor. In some examples, the slice can be selected from a subset of channels of the quantized hyperlatent values \hat{z}ₜ, for example, by taking the first 64 of 128 channels present in the tensor. The slice values are then expanded to the same dimensions of the quantized latent (for example, expanded from 2×2×64 to 16×16×128). For example, the slice values can be expanded by copying the values to form a padded array of scales σ. In other examples, different slice and expand dimensions and techniques can be used.

The scales are then combined with the mean produced using the hyperdecoder (464). In the illustrated example, the hyperlatent values \hat{z}ₜ are provided to a machine learning model (421) (such as a convolutional neural network) to produce a tensor of first intermediate mean values μ₀. The latent values y decoded from the bitstream via computer-readable media (438) are shifted according to the first set of intermediate mean values μ₀ (for example, by adding individual elements of tensor μ₀ to the corresponding tile of the latent values y) to produce a first intermediate quantized latent ŷₜ₀. The first intermediate quantized latent ŷₜ₀ and the first set of intermediate mean values μ₀ are provided to a machine learning model (422) (such as a convolutional neural network) to produce a tensor for a second set of intermediate mean values μ₁.

The latent values y decoded from the bitstream via computer-readable media (438) are shifted according to the second set of intermediate mean values μ₁ (for example, by adding individual elements of tensor μ₁ to the corresponding tile of the latent values y) to produce a second intermediate quantized latent ŷₜ₁.

The first intermediate quantized latent ŷₜ₀. second intermediate quantized latent ŷₜ₁. are combined to produce the decoded quantized latent values ŷₜ. As will be readily understood to a person of ordinary skill in the art having the benefit of the present disclosure, a number of different methods of combination can be used. For example, the intermediate quantized latents ŷₜ₀ and ŷₜ₁ can be combined by addition (with or without an additional weight), multiplication, concatenation, or other suitable methods. The decoded quantized latent values, are provided to the decoder (416) to produce the reconstructed frame(s) \hat{x}ₜ and features fₜ (424).

### A. Example Tensor Sizes

Table 2 below shows an example of tensor size as can be used for the video codec system depicted in FIGS. 4A-4B. This table is provided to further detail the operation of the video codec system, but as will be readily understood to a person of ordinary skill in the art having the benefit of the present disclosure, such systems are not limited to the specific resolution of the tensor dimensions shown in the table.

TABLE 2

| Symbol | Description | Tensor Size |
|---|---|---|
| x | input image | 256 × 256 × 3 |
| y | latents | 16 × 16 × 128 |
| ŷ | quantized latents | 16 × 16 × 128 |
| z | hyperlatents | 2 × 2 × 128 |
| \hat{z} | quantized hyperlatents | 2 × 2 × 128 |
| ⊂\hat{z} | subset of the quantized | 2 × 2 × 64 |
| | hyperlatents | |
| μ | predicted means | 16 × 16 × 128 |
| σ | predicted scales | 16 × 16 × 128 |
| \hat{x} | decoded latents for image | 256 × 256 × 3 |
| | reconstruction | |
| f | features used to contextually | 32 × 32 × 128 |
| | compress the next frame | |
| F | context used in the encoder, | 32 × 32 × 128 |
| | decoder, and entropy | |
| | parameters module | |

### V. Example Variations of Neural Codec Systems

Depending on implementation and the type of compression/decompression desired, modules of neural codec system, including neural image codec systems and neural video codec system can be added, omitted, split into multiple modules, combined with other modules, and/or replaced with like modules. Further, the relationships shown between modules within the example encoders (340, 440) and the neural decoders (350, 450) indicate general flows of information in encoders or decoders, respectively; other relationships are not shown for the sake of simplicity. In general, a given module of the neural codec system can be implemented by software executable on a CPU, by software controlling special-purpose hardware (e.g., graphics hardware for video acceleration, such as a graphics processing unit (GPU) or hardware for accelerating neural network operations, such as a neural processing unit (NPU), or by special-purpose hardware (e.g., in an ASIC).

Convolutional neural networks (“CNNs”) are used in several components of the neural video codec system and neural image codec systems described herein. Generally, a CNN includes one or more convolutional layers. A convolutional layer includes a set of filters (also referred to as kernels), parameters of which can be learned through a training process. The convolutional layer computes the convolutional operation of input values for an input image or a video frame (e.g., sample values, MV values for a first layer; or outputs from a previous layer for later layers) using kernels to extract fundamental features embedded in the image or video frame. The size of the kernels is typically smaller than the input image or video frame. Each kernel convolves with the image or video frame and creates an activation map (also referred to as “feature map”) made of neurons. The output volume of a convolutional layer is obtained by stacking the activation maps of all kernels along a depth dimension (example of channel dimension). In addition to convolutional layers, some CNNs can also include one or more sub-pixel convolutional layers, one or more pooling layers, and/or one or more non-linear activation function (such as “ReLU”) layers. A sub-pixel convolutional layer performs a standard convolutional operation followed by a pixel-shuffling operation. Placed between two convolutional layers, a pooling layer receives a plurality of activation maps and applies a pooling operation to each of them so as to reduce the spatial dimension while preserving important characteristics of the activation maps. A ReLU layer acts as an activation function by replacing all negative values received as inputs by zeros.

Further, while the machine learning models and neural networks described herein often refer to CNNs, it will be readily understood to a person of ordinary skill in the relevant art that other types of neural networks, including but not limited to general feed-forward artificial neural networks or recurrent neural networks can be used to implement one or more portions of the machine learning models described herein. Furthermore, while the operations performed by the machine learning model are described as separate modules, it will be readily understood that in some examples, all or some of the models may act as a single model (e.g., a single neural network) that is trained and used as a single model, two cooperative models, or additional models.

### VI. Example Method of Encoding or Decoding Digital Media Having Encoded Latents

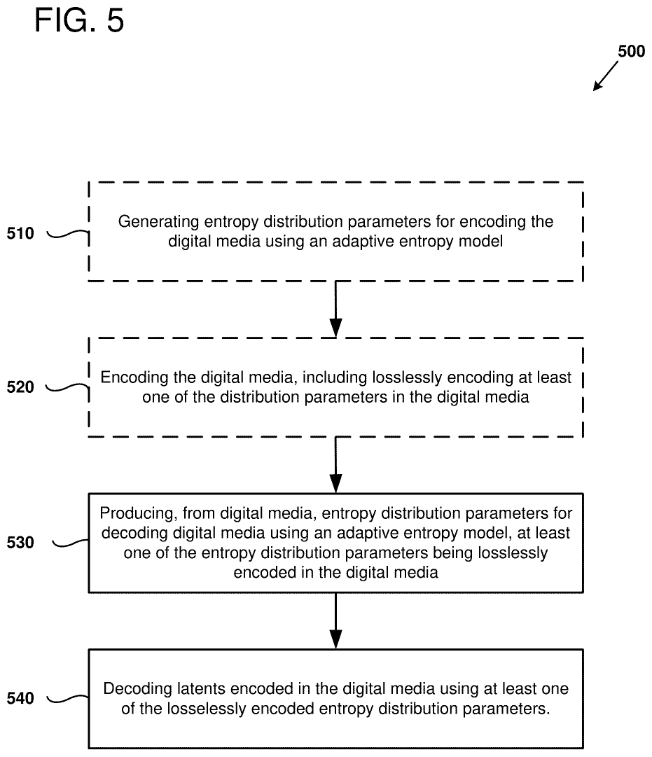

FIG. 5 is a flow chart (500) outlining an example method of encoding and/or decoding digital media having encoded latents, as can be performed in certain examples of the disclosed technology. For example, the illustrated method can be implemented using the systems described above regarding FIGS. 3A and 3B or FIGS. 4A and 4B. As will be readily understood to a person of ordinary skill in the art having the benefit of the present disclosure, other suitable systems can be adapted to perform the method outlined in the flow chart (500).

At process block (510), entropy distribution parameters are generated for encoding digital media using an adaptive entropy model. For example, the encoded digital media can include images or video. In some examples, the adaptive entropy model includes an entropy distribution modeled as an adaptive Gaussian distribution having mean and scale parameters. In some examples, at least one of the entropy distribution parameters comprises a scale parameter. In some examples, other entropy distribution parameters can include mean values for the distribution.

At process block (520), the digital media is encoded (for example, including the images or video). At least one of the entropy distribution parameters generated at process block (510) is losslessly encoded in the digital media. Latents and hyperlatents can be generated for including in the digital media. The digital media may be transmitted via a computer-readable media (for example, via a computer network) or stored in a computer-readable storage medium. Entropy distribution parameters can be shared. For example, two or more latents can be encoded using at least one shared entropy distribution parameter. In some examples, the digital media is communicated using two bitstreams, one bitstream including the encoded latents and the second bitstream including the losslessly encoded entropy distribution parameters. In other examples, the digital media is communicated using one bitstream including the encoded latents and the losslessly encoded entropy distribution parameters. The latents or hyperlatents can be stored in a computer-readable storage media or transmitted via a computer-readable media (for example, via a computer network. In some examples, at least one of the losslessly encoded entropy distribution parameters is an index for a set of predefined discrete probability distributions, wherein the index is used to decode at least one value encoded in the digital media using the adaptive entropy model. In some examples, the set of predefined discrete probability distributions includes at least one discretized Gaussian distributions having a scale parameter. The scale parameter can be encoded using the index for a set of predefined discrete probability distributions encoded in the digital media

At process block (530), entropy distribution parameters are produced from the digital media. The entropy distribution parameters can be used for decoding the digital media using the adaptive entropy model. At least one of the entropy distribution parameters is losslessly encoded in the digital media. For example digital media received via a computer-readable media, such as a computer network, or read from a computer-readable storage medium can be used. In some examples, at least some of the entropy distribution parameters are parameters predicted from hyperlatents encoded in the digital media.

At process block (540), latents for the digital media are decoded using an adaptive entropy models and at least one of the entropy distribution parameters produced at process block (530). The latents or hyperlatents from the digital media can be used, for example, for reconstructing images or video encoded in the digital media. The latents can be decoded using at least one of the predicted entropy distribution parameters.

In some examples, all acts associated with process blocks (510, 520, 530, 540) are performed. In some examples, a method of encoding images or video includes the acts associated with process blocks (510, 520). In some examples, a method of decoding images or video includes the acts associated with process blocks (510, 520). In some examples, all acts associated with process blocks (510, 520, 530, 540) are performed, with the acts of 510 and 520 being performed by a first actor and the acts of 530 and 540 being performed by a different actor.

Table 3 below shows some of the innovative aspects described herein for decoding and/or encoding digital media using a cross-platform neural codec using transmitted entropy distribution parameters.

TABLE 3

| | Aspect |
|---|---|
| A1 | A method of decoding digital media having encoded latents, the method |
| | comprising: |
| | with a processor: |
| | producing, from the digital media, entropy distribution parameters for decoding |
| | the digital media using an adaptive entropy model, at least one of the entropy |
| | distribution parameters having been losslessly encoded in the digital media; and |
| | decoding the encoded latents from the digital media using at least one of the |
| | losslessly encoded entropy distribution parameters. |
| A2 | The method of A1, wherein: |
| | the adaptive entropy model uses an entropy distribution modeled as an |
| | adaptive Gaussian distribution having mean and scale parameters; and |
| | at least one of the entropy distribution parameters comprises a scale |
| | parameter. |
| A3 | The method of A2, wherein the scale parameter is used to decode a first latent |
| | and a second, different latent from the digital media. |
| A4 | The method of any of A1-A3, wherein: |
| | the digital media comprises a first bitstream comprising the encoded |
| | entropy distribution parameters; and |
| | the digital media comprises a second bitstream comprising the latents. |
| A5 | The method of any of A1-A4, further comprising: |
| | producing predicted entropy distribution parameters from hyperlatents encoded |
| | in the digital media; and |
| | the decoding the encoded latents from the digital media further comprises using |
| | at least one of the predicted entropy distribution parameters. |
| A6 | The method of A5, further comprising: |
| | storing the hyperlatents in a computer-readable storage media or |
| | transmitting the hyperlatents via a computer network. |
| A7 | The method of any of A1-A6, wherein at least one of the losslessly encoded |
| | entropy distribution parameters is an index for a set of predefined discrete |
| | probability distributions, wherein the index is used to decode at least one value |
| | encoded in the digital media using the adaptive entropy model. |
| A8 | The method of any of A1-A7, wherein the set of predefined discrete probability |
| | distributions comprises at least one discretized Gaussian distributions having a |
| | scale parameter, further comprising: |
| | producing the scale parameter using the index for a set of predefined |
| | discrete probability distributions encoded in the digital media; or |
| | producing the scale parameter using data encoded in the digital media, and |
| | optionally wherein the scale parameter is produced using a predetermined |
| | mathematical formula using the data encoded in the digital media. |
| A9 | The method of any of A1-A8, wherein the adaptive entropy model comprises an |
| | entropy distribution modeled as an adaptive Gaussian distribution having mean |
| | and scale parameters, the method further comprising: |
| | decoding hyperlatents from the digital media; |
| | producing combined quantized latents for reconstructing images or video |
| | based on the decoded latents; and |
| | producing at least one of the scale parameters by slicing and expanding |
| | the decoded hyperlatents, at least one of the scale parameters being shared by at |
| | least two latents encoded in the digital media. |
| A10 | 1The method of A9, further comprising producing the mean parameters by: |
| | producing first mean values from the decoded hyperlatents using a first |
| | machine learning model, |
| | producing first quantized latents by shifting the decoded latents |
| | according to the first mean values, |
| | producing second mean values from the first mean values using a second |
| | neural network, |
| | producing second quantized latents by shifting the decoded latent values |
| | according to the second mean values, and |
| | the decoding the latents comprises producing combined quantized latents |
| | using the first quantized latents and the second quantized latents. |
| A11 | The method of A10, wherein: |
| | the decoding the latents or the decoding the hyperlatents is performed using a |
| | decoder neural network, wherein the scale parameters used to encode the digital |
| | media are determined after training the decoder neural network. |
| A12 | The method of A10, wherein: |
| | the latents and hyperlatents are represented in a floating-point format and the |
| | encoded latents and hyperlatents are represented in an integer format; |
| | the digital media comprises encoded individual images, video, or individual |
| | images and video; and |
| | the hyperlatents comprise scale parameters used to entropy encode the latents. |
| A13 | The method of A12, wherein the digital media is received via a computer |
| | network, the digital media comprises digital images, video, or digital images and |
| | video, the method further comprising: |
| | using the decoded latents, reconstructing the digital images, video, or digital |
| | images and video; and |
| | displaying the digital images, video, or digital images and video using a display. |
| A14 | The method of A13, further comprising: |
| | generating the latents by encoding the digital media using a neural network |
| | encoder; |
| | generating the entropy distribution parameters using and adaptive entropy |
| | model; |
| | encoding the latents and the entropy distribution parameters in the digital media; |
| | and |
| | sending the latents and the entropy distribution parameters via a computer- |
| | readable media, |
| | wherein a first system comprising a processor used to perform the encoding the |
| | digital media produces different entropy distribution parameters than a second |
| | system comprising the processor decoding the digital media due to differences in |
| | the representation of the latents, hyperlatents, or entropy distribution parameters |
| | between the first system and the second system. |
| A15 | The method of A14, wherein the digital media comprises video, the method |
| | further comprising: |
| | extracting a feature from a first frame of the video and producing context based |
| | on the extracted feature; and |
| | encoding the digital media by encoding a second frame of the video using the |
| | context, wherein a parameter used to entropy encode the digital media is based |
| | on the produced context. |
| A16 | The method of any of A1-A15, further comprising: storing the entropy |
| | distribution parameters for the adaptive entropy model in a computer-readable |
| | storage media or transmitting the entropy distribution parameters via a computer |
| | network. |
| A17 | A computer-readable storage media storing computer-executable instructions, |
| | which when executed by a processor, cause the processor to perform the method |
| | of any of A1-A16. |
| A18 | A system comprising computer-readable storage media, a processor selected |
| | from the group comprising a central processing unit, a graphics processing unit, |
| | or a neural processing unit, optionally having a network interface to transmit |
| | and/or receive a bitstream comprising quantized latents and/or quantized |
| | hyperlatents via the network interface or a computer-readable media, and |
| | optionally having display interface to cause a display to display video or images |
| | encoded in the received bitstream produced by the method of any of A1-A16. |
| A19 | Any of A1-A18 using a different type of processor than the processor or |
| | machine learning model used to encode the digital media. |
| A20 | Any of A1-A19 using a different machine learning model than the machine |
| | learning model used to encode the digital media. |

### VII. Example Method of Decoding Images or Video Using Transmitted Entropy Distribution Parameters

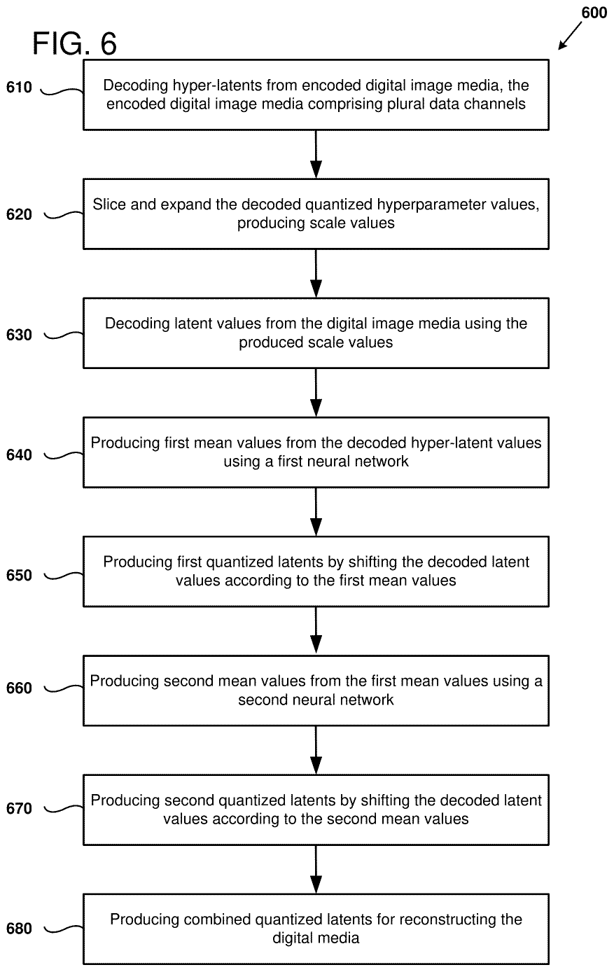

FIG. 6 is a flow chart (600) outlining an example method of decoding video using a neural image or video decoder as can be performed in certain examples of the disclosed technology. For example, the illustrated method can be implemented using the systems described above regarding FIGS. 3A and 3B or FIGS. 4A and 4B. As will be readily understood to a person of ordinary skill in the art having the benefit of the present disclosure, other suitable systems can be adapted to perform the method outlined in the flow chart (600).

At process block (610) quantized hyperlatents are decoded from an encoded digital image media which comprises plural data channels. For example, an arithmetic decoder (362, 462) and factorized entropy model can be used to decode hyperlatents from the bitstream received via computer-readable media (348, 448).

At process block (620) the decoded quantized hyperparameter values from the decoded hyperlatents are sliced and expanded. For example, the slice and expand module (366, 466) can be used to slice and expand.

At process block (630) latent values are decoded from the digital image media using the produced scale values. For example, an arithmetic decoder AD (312, 412) can be used to decode the latents.

At process block (640) first mean values are produced from the decoded hyperlatents using a first neural network. As discussed in further detail above, a machine learning model (321, 421) can be used to generate the first mean values from the decoded hyper latent values produced at process block (610).

At process block (650) first latents are produced by shifting the decoded latent values according to the first mean values. For example, a mean value corresponding to a particular quantized latent can be shifted by adding, or other suitable method of shifting. For example, a shifter (368, 468) can be used to shift the latents according to the first mean values.

At process block (660) second mean values are produced from the first mean values using a second neural network that has been trained. As discussed in further detail above, a machine learning model (322, 422) can be used to generate the second mean values from the decoded hyper latent values produced at process block (610).

At process block (670) second latents are produced by shifting the decoded latent values according to the second mean values. For example, similar shifting techniques such as those described above regarding process block (650) may be used with a shifter (369, 469).

At process block (680) the first and second latents are combined to produce a latent for reconstructing the digital media. The reconstructed frame can be output and displayed as an image or video as discussed in further detail above.

Table 4 below shows some of the innovative aspects described herein for decoding and/or encoding data such as images and video in digital media using a cross-platform neural codec using transmitted entropy distribution parameters.

TABLE 4

| | Aspect |
|---|---|
| B1 | A method of decoding digital media, the method comprising: |
| | with a processor: |
| | producing entropy distribution parameters decoded from the digital media; |
| | producing predicted entropy distribution parameters from the digital media using |
| | a machine learning model; and |
| | decoding entropy-coded latents from the digital media based on the produced |
| | entropy distribution parameters and the predicted entropy distribution |
| | parameters. |
| B2 | The method of B1, wherein the produced entropy distribution parameters |
| | comprise scales and the predicted entropy distribution parameters comprise |
| | means. |
| B3 | The method of B1 or B2, wherein the produced entropy distribution parameters |
| | are shared by at least two groups of latents encoded in the digital media. |
| B4 | The method of any of B1-B3, wherein the produced entropy distribution |
| | parameters are losslessly encoded in the digital media. |
| B5 | The method of any of B1-B4, wherein: |
| | the entropy distribution parameters are for an adaptive entropy model, |
| | the adaptive entropy model uses an entropy distribution modeled as an |
| | adaptive Gaussian distribution having mean and scale parameters; and |
| | at least one of the entropy distribution parameters comprises a scale |
| | parameter. |
| B6 | The method of any of B1-B5, wherein the digital media comprises hyperlatents |
| | and the entropy-coded latents. |
| B7 | The method of B6, further comprising: |
| | decoding hyperlatents from encoded digital media, the encoded digital media |
| | comprising plural data channels; and |
| | producing combined quantized latents for reconstructing digital media based on |
| | the decoded entropy-coded latents; |
| | wherein the producing the scales is performed by slicing and expanding the |
| | decoded hyperlatents, the decoded hyperlatents having plural channels, at least |
| | one of the scales being shared by at least two groups of latents encoded in the |
| | digital media; and |
| | wherein the producing predicted mean values comprises: |
| | producing first mean values from the decoded hyperlatents using a first machine |
| | learning model, |
| | producing first quantized latents by shifting the decoded latents according to the |
| | first mean values, |
| | producing second mean values from the first mean values using a second neural |
| | network, |
| | producing second quantized latents by shifting the decoded latent values |
| | according to the second mean values, and |
| | the decoding the entropy-coded latents comprises producing combined quantized |
| | latents using the first quantized latents and the second quantized latents. |
| B8 | The method of B6, wherein the scales are produced by the decoded hyperlatents |
| | and copying the hyperlatents to produce the first quantized latents and/or the |
| | second quantized latents. |
| B9 | The method of any of B6-B8, wherein: |
| | the decoding the latents or the decoding the hyperlatents is performed using a |
| | decode neural network, wherein the scales used to encode the digital media are |
| | determined after training the decode neural network. |
| B10 | The method of any of B6-B9 wherein the hyperlatents are image-dependent. |
| B11 | The method of any of B1-B10, wherein the digital media is received via a |
| | computer network, the digital media comprises digital images, video, or digital |
| | images and video, the method further comprising: |
| | reconstructing the digital media; and |
| | displaying the digital media using a display. |
| B12 | The method of any of B2, B5, or B7-B11, wherein the scales comprise a |
| | probability distribution for an entropy decoder. |
| B13 | The method of any of B6-B12, wherein: |
| | the latents and hyperlatents are represented in a floating-point format and the |
| | encoded latents and hyperlatents are represented in an integer format; |
| | the digital media comprises individual images, video, or individual images and |
| | video; and |
| | the hyperlatents comprise scale values used to entropy encode the latent values. |
| B14 | The method of any of B6-B13, further comprising encoding the digital media |
| | by: |
| | producing the latents by encoding the digital media with a neural network |
| | encoder; |
| | generating hyperlatents from the latents by determining scale values; |
| | quantizing the hyperlatents; |
| | encoding the quantized hyperlatents by selecting scale values shared by at least |
| | two of the hyperlatents; and |
| | sending the quantized hyperlatents to the decoder via a computer-readable |
| | media, |
| | wherein a processor used to perform the encoding the digital media produces |
| | different entropy parameters than the processor decoding the digital media due |
| | to differences in floating point arithmetic used in encoding or decoding the |
| | digital media, respectively. |
| B15 | The method of any of B1-B14, wherein the digital media comprises video, the |
| | method further comprising: |
| | extracting a feature from a first frame of the video and producing context based |
| | on the extracted feature; and |
| | encoding the digital media by encoding a second frame of the video using the |
| | context, wherein a parameter used to entropy encode the digital media is based |
| | on the produced context. |
| B16 | The method of B14 or B15, wherein a predictive probability model uses the |
| | scale values and means for a Gaussian distribution used to decode the latents. |
| B17 | The method of any of B6-B16, further comprising: storing the hyperlatents in a |
| | computer-readable storage media or transmitting the hyperlatents via a computer |
| | network. |
| B18 | A computer-readable storage media storing computer-executable instructions, |
| | which when executed by a processor, cause the processor to perform the method |
| | of any of B1-B17. |
| B19 | A system comprising computer-readable storage media, a processor selected |
| | from the group comprising a central processing unit, a graphics processing unit, |
| | or a neural processing unit, optionally having a network interface to transmit |
| | and/or receive a bitstream comprising quantized latents and/or quantized |
| | hyperlatents via the network interface or a computer-readable media, and |
| | optionally having display interface to cause a display to display video or images |
| | encoded in the received bitstream produced by the method of any of B1-B18. |
| B20 | Any of B1-B19 using a different type of processor than the processor or |
| | machine learning model used to encode the digital media. |
| B21 | Any of B1-B20 using a different machine learning model than the machine |
| | learning model used to encode the digital media. |
| C1 | A method of decoding images or video with a machine learning tool, the |
| | instructions comprising instructions that cause a processor to produce a scale |
| | value from a received hyperlatent for decoding a latent tensor from a bitstream; |
| | with a machine learning tool, generate a predicted mean value from the received |
| | hyperlatent; and to decode the latent tensor based on the produced scale value |
| | and the mean value, the scale value being used to determine at least two |
| | elements of a decoded quantized latent. |
| C2 | The method of C1, further comprising generating the predicted mean value by |
| | producing a first mean value from the received hyperlatent, shifting at least one |
| | entropy-decoded latent, and producing second means values from the first mean |
| | values and the shifted entropy-decoded latent. |
| C3 | The method of C1 or C2, further comprising encoding the images or video. |
| C4 | The method of any of C1-C3, further comprising: storing the hyperlatents in a |
| | computer-readable storage media or transmitting the hyperlatents via a computer |
| | network. |
| C5 | A computer-readable storage media storing computer-executable instructions, |
| | which when executed by a processor, cause the processor to perform the method |
| | of any of C1-C4. |
| C6 | A system comprising computer-readable storage media, a processor selected |
| | from the group comprising a central processing unit, a graphics processing unit, |
| | or a neural processing unit, optionally having a network interface to transmit |
| | and/or receive a bitstream comprising quantized latents and/or quantized |
| | hyperlatents via the network interface or a computer-readable media, and |
| | optionally having display interface to cause a display to display video or images |
| | encoded in the received bitstream produced by the method of any of C1-C6 |
| C7 | Any of C1-C6 using a different type of processor than the processor or machine |
| | learning model used to encode the digital media. |
| C8 | Any of C1-C7 using a different machine learning model than the machine |
| | learning model used to encode the digital media. |

### VIII. Example Method of Encoding Images or Video Using Transmitted Entropy Distribution Parameters

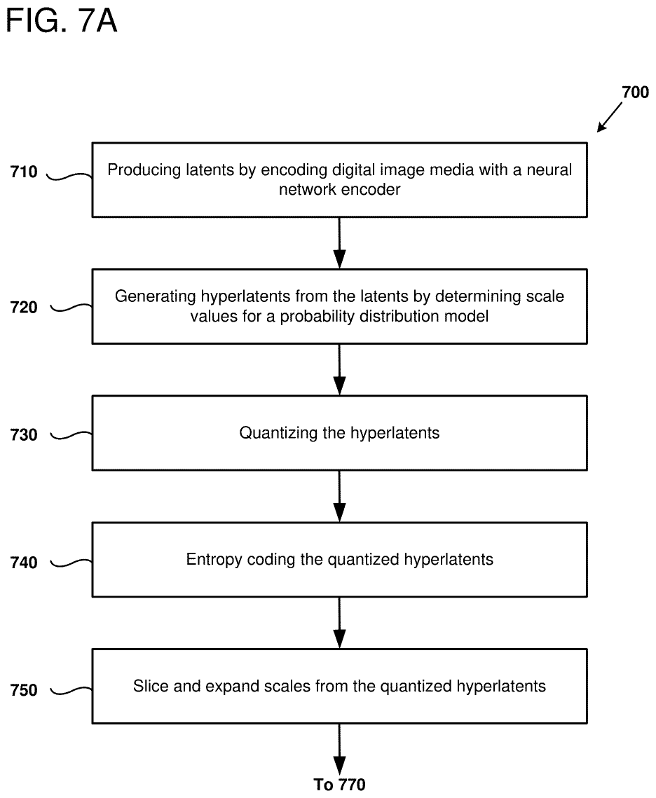

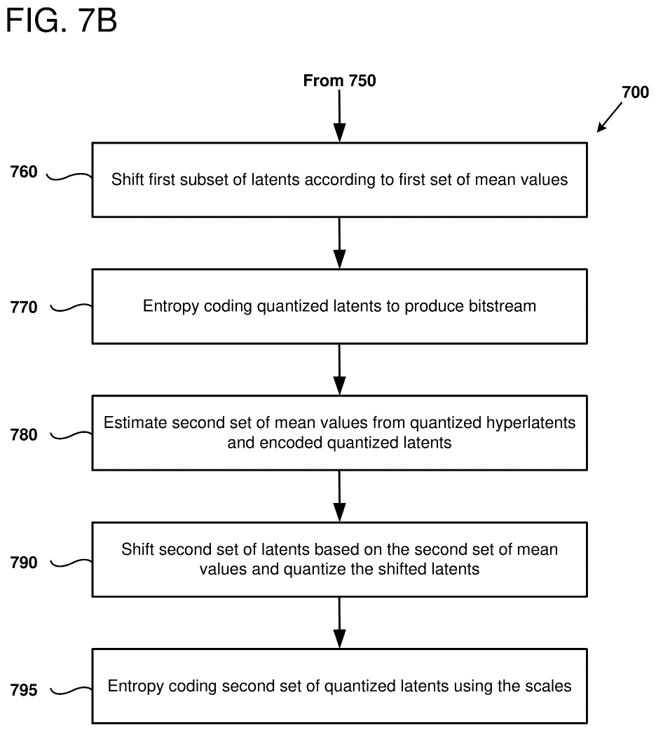

FIGS. 7A-7B depict a flow chart (700) outlining an example method of encoding video using a neural image or video decoder as can be performed in certain examples of the disclosed technology. For example, the illustrated method can be implemented using the system described above regarding FIGS. 3A and 3B or FIGS. 4A and 4B. As will be readily understood to a person of ordinary skill in the art having the benefit of the present disclosure, other suitable systems can be adapted to perform the method outlined in the flow chart (700).

At process block (710), latents are produced by encoding digital image media using a neural network encoder. For example, the encoder (304) or encoder (404) discussed above can be used to encode digital image media.

At process block (720) hyperlatents are generated from the latents produced at process block (710), which also include scale values for a probability distribution model. For example, the hyperencoder (344) or hyperencoder (444) discussed above can be used to generate scale values for a probability distribution model.

At process block (730), the hyperlatents are quantized, for example, using the quantizer (346) or quantizer (446) as discussed above.

At process block (740), the quantized hyperlatents are entropy coded using a factorized entropy model. For example, the arithmetic encoder (358) or arithmetic encoder (458) can be used to entropy code the quantized hyperlatents with use of a factorized entropy model (360) or factorized entropy model (460), respectively. The quantized hyperlatents may be sent to a decoder via computer world readable media. The bitstream can be decoded using methods disclosed herein, for example, the method outlined in the flow chart (500) of FIG. 5 or the flow chart (600) of FIG. 6.

At process block (750), scales are separated from the quantized hyperlatents and expanded to the size of the latents produced at process block (710), as shown at (377, 477). A first set of mean values are estimated using a hyperdecoder based on the quantized hyperlatents using a machine learning model (e.g., 321, 421 as discussed above), for example, a neural network.

At process block (760), a first subset of the latents (for example, one half of the latents) are shifted according to the mean values estimated at process block (750), and this first subset of latents is quantized. For example, a shifter (368, 468) may be used to shift the subset of latents according to the mean values.

At process block (770), the quantized latents from process block (760) are converted to a bitstream using, for example, an arithmetic encoder AE (308, 408) based on a discretized Gaussian distribution with the scales produced at process block (750).

At process block (780), a second set of mean values are estimated based on the quantized hyperlatents produced at process block (740) and the encoded quantized latents. For example, the machine learning models (322) or (422) can be used to estimate the second mean values.

At process block (790), a second set of latents, for example, all of the remaining (unshifted) latents are shifted based on the second set of mean values estimated at process block (780). The second set of shifted latents is then quantized.

At process block (795), the second set of quantized latents are converted to a bitstream using, for example, an arithmetic encoder based on a discretized Gaussian distribution with the scales produced at process block (750). At least some of the transmitted entropy distribution parameters can be losslessly encoded in the bitstream, for example, the scales produced at process block (750).

### IX. Example Method of Training Neural Networks for Implementing Encoders and Decoders Using Transmitted Entropy Distribution Parameters

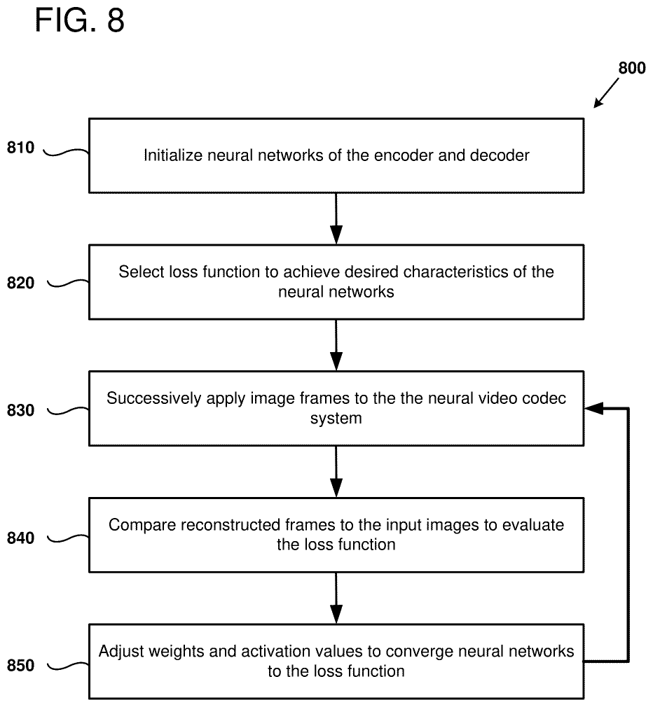

FIG. 8. is a flow chart (800) outlining an example method of training neural networks for implementing encoders and decoders that use transmitted entropy distribution parameters as can be implemented in some examples of the disclosed technology. For example, the illustrated method can be used to train one or more, or all, of the neural network portions of the encoding and decoding systems discussed above regarding FIGS. 3A and 3B, and FIGS. 4A and 4B. At a high level, the neural network may be trained by initializing the network parameters, providing data at the model inputs, propagating the data through the network, computing a loss function, and updating model weights for the network using the loss function. In many examples, the entire neural network used to implement the codec is trained jointly. At least some of the transmitted entropy distribution parameters can be losslessly encoded.

At process block (810), the neural networks of the encoder, decoder, and prior probability models are initialized. In the example neural image codec system (300) of FIG. 3A-3B, the encoder (304) the hyperencoder (344), the context model (310), the decoder (316), and the hyperdecoder (364) can be implemented using convolutional neural networks.

At process block (820), a loss function is selected to achieve desired characteristics of the trained network. For example, loss function may represent a desired compression efficiency or reconstruction quality.

At process block (830, 840), the neural networks are trained by successively applying image frames from a training data set to the system, encoding the images, and comparing the resulting reconstructed frames to the input images by evaluating the loss function.

At process block (850), weights in the neural network are adjusted to converge the loss function. During the training, the entropy coders and entropy decoders are replaced by proxies to estimate the bit rate by applying Shannon's law.

Table 5 below shows some of the innovative aspects described herein for training neural networks that can be used in decoding and/or encoding digital media using a cross-platform neural codec using transmitted entropy distribution parameters.

TABLE 5

| | Aspect |
|---|---|
| D1 | A method of training neural networks for encoding video, the method |
| | comprising: |
| | selecting a loss function to achieve desired characteristics of a neural |
| | encoder/decoder system comprising at least one neural network; |
| | successively encoding and decoding images from a training set applied to the |
| | neural encoder/decoder system; |
| | comparing reconstructed frames generated by the encoder/decoder system to |
| | images from the training set to evaluate the loss function; and |
| | adjusting parameters of the at least one neural network to converge the neural |
| | networks. |
| D2 | The method of D1, further comprising storing weights or activation values for |
| | the trained neural networks in a computer-readable storage medium. |
| D3 | A system comprising computer-readable storage media, a processor selected |
| | from the group comprising a central processing unit, a graphics processing unit, |
| | or a neural processing unit, optionally having a network interface to transmit |
| | and/or receive a bitstream comprising quantized latents and/or quantized |
| | hyperlatents via the network interface used to train a neural network by the |
| | method of D1 or D2. |
| D4 | Any of D1-D3 implemented using a different type of processor than the |
| | processor or machine learning model used to encode the digital media. |
| D5 | Any of D1-D4 implemented using a different machine learning model than the |
| | machine learning model used to encode the digital media. |
| D6 | Performing the method of any of A1-A16, A19, A20, B1-B17, B20, B21, C1- |
| | C4, C7, or C8 using a neural network trained according to the method of D1, D2, |
| | D4, or D5. |
| D7 | A computer-readable storage media storing computer-executable instructions, |
| | which when executed by a processor, cause the processor to perform the method |
| | of any of D1, D2, or D4-D6. |

### X. Example Computer Systems

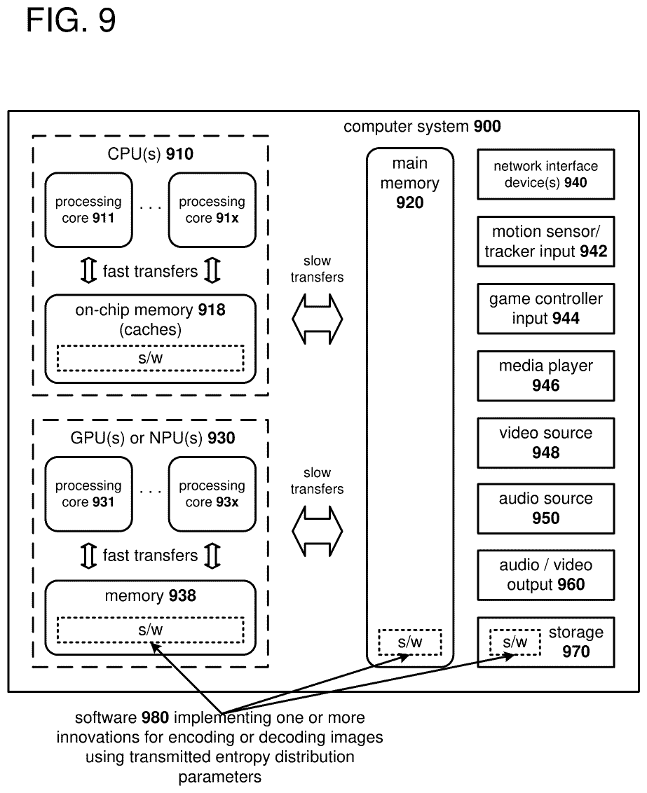

FIG. 9 illustrates a generalized example of a suitable computer system (900) in which several of the described innovations may be implemented. The innovations described herein relate to implementing cross-platform neural codecs using transmitted entropy distribution parameters. The computer system (900) is not intended to suggest any limitation as to scope of use or functionality, as the innovations may be implemented in diverse computer systems, including special-purpose computer systems.

With reference to FIG. 9, the computer system (900) includes one or more processing cores (911 . . . 91x) and local memory (918) of a central processing unit (“CPU”) (910) or multiple CPUs. The processing core(s) (911 . . . 91x) are, for example, processing cores on a single chip, and execute computer-executable instructions. The number of processing core(s) (911 . . . 91x) depends on implementation and can be, for example, 4 or 9. The local memory (918) may be volatile memory (e.g., registers, cache, random access memory (“RAM”)), non-volatile memory (e.g., read-only memory (“ROM”), electrically erasable programmable ROM (“EEPROM”), flash memory), or some combination of the two, accessible by the respective processing core(s) (911 . . . 91x). Alternatively, the processing cores (911 . . . 91x) can be part of a system-on-a-chip (“SoC”), application-specific integrated circuit (“ASIC”), or other integrated circuit.

The local memory (918) can store software (980) implementing aspects of the innovations for implementing cross-platform neural codecs using transmitted entropy distribution parameters, for operations performed by the respective processing core(s) (911 . . . 91x), in the form of computer-executable instructions. In FIG. 9, the local memory (918) is on-chip memory such as one or more caches, for which access operations, transfer operations, etc. with the processing core(s) (911 . . . 91x) are fast.

The computer system (900) also includes processing cores (931 . . . 93x) and local memory (938) of a graphics processing unit (“GPU”) or neural processing unit (“NPU”) (930), or multiple GPUs or NPUs. The number of processing cores (931 . . . 93x) of the GPU or NPU depends on implementation. For a GPU, the processing cores (931 . . . 93x) are, for example, part of single-instruction, multiple data (“SIMD”) units of the GPU. The SIMD width n, which depends on implementation, indicates the number of elements (sometimes called lanes) of a SIMD unit. For an NPU, the processing cores (931 . . . 93x) include, for example, specialized ML hardware blocks for operations such as matrix multiplication and convolution. The memory (938) may be volatile memory (e.g., registers, cache, RAM), non-volatile memory (e.g., ROM, EEPROM, flash memory), or some combination of the two, accessible by the respective processing cores (931 . . . 93x). The memory (938) can store software (980) implementing aspects of the innovations for implementing cross-platform neural codecs using transmitted entropy distribution parameters, for operations performed by the respective processing cores (931 . . . 93x), in the form of computer-executable instructions such as shader code (for a GPU) or specialized code for ML hardware blocks (for an NPU).

The computer system (900) includes main memory (920), which may be volatile memory (e.g., RAM), non-volatile memory (e.g., ROM, EEPROM, flash memory), or some combination of the two, accessible by the processing core(s) (911 . . . 91x, 931 . . . 93x). The main memory (920) stores software (980) implementing aspects of the innovations for implementing cross-platform neural codecs using transmitted entropy distribution parameters in the form of computer-executable instructions. In FIG. 9, the main memory (920) is off-chip memory, for which access operations, transfer operations, etc. with the processing cores (911 . . . 91x, 931 . . . 93x) are slower.

More generally, the term “processor” refers generically to any device that can process computer-executable instructions and may include a microprocessor, microcontroller, programmable logic device, digital signal processor, and/or other computational device. A processor may be a processing core of a CPU, other general-purpose unit, GPU, or NPU. A processor may also be a specific-purpose processor implemented using, for example, an ASIC or a field-programmable gate array (“FPGA”). A “processor system” is a set of one or more processors, which can be located together or distributed across a network.

The term “control logic” refers to a controller or, more generally, one or more processors, operable to process computer-executable instructions, determine outcomes, and generate outputs. Depending on implementation, control logic can be implemented by software executable on a CPU, by software controlling special-purpose hardware (e.g., a GPU, other graphics hardware, or an NPU), or by special-purpose hardware (e.g., in an ASIC).

The computer system (900) includes one or more network interface devices (940). The network interface device(s) (940) enable communication over a network to another computing entity (e.g., server, other computer system). The network interface device(s) (940) can support wired connections and/or wireless connections, for a wide-area network, local-area network, personal-area network, or other network. For example, the network interface device(s) can include one or more Wi-Fi® transceivers, an Ethernet® port, a cellular transceiver and/or another type of network interface device, along with associated drivers, software, etc. The network interface device(s) (940) convey information such as computer-executable instructions, audio or video input or output, or other data in a modulated data signal over network connection(s). A modulated data signal is a signal that has one or more of its characteristics set or changed in such a manner as to encode information in the signal. By way of example, the network connections can use an electrical, optical, RF, or other carrier.

The computer system (900) optionally includes a motion sensor/tracker input (942) for a motion sensor/tracker, which can track the movements of a user and objects around the user. For example, the motion sensor/tracker allows a user (e.g., player of a game) to interact with the computer system (900) through a natural user interface using gestures and spoken commands. The motion sensor/tracker can incorporate gesture recognition, facial recognition and/or voice recognition.

The computer system (900) optionally includes a game controller input (944), which accepts control signals from one or more game controllers, over a wired connection or wireless connection. The control signals can indicate user inputs from one or more directional pads, buttons, triggers and/or one or more joysticks of a game controller. The control signals can also indicate user inputs from a touchpad or touchscreen, gyroscope, accelerometer, angular rate sensor, magnetometer and/or other control or meter of a game controller.

The computer system (900) optionally includes a media player (946) and video source (948). The media player (946) can play DVDs, Blu-Ray™ discs, other disc media and/or other formats of media. The video source (948) can be a camera input that accepts video input in analog or digital form from a video camera, which captures natural video. Alternatively, the video source (948) can be a screen capture module (e.g., a driver of an operating system, or software that interfaces with an operating system) that provides screen capture content as input. Or, as another alternative, the video source (948) can be a graphics engine that provides texture data for graphics in a computer-represented environment. Or, as another alternative, the video source (948) can be a video card, TV tuner card, or other video input that accepts input video in analog or digital form (e.g., from a cable input, High-Definition Multimedia Interface (“HDMI”) input or other input).

An optional audio source (950) accepts audio input in analog or digital form from a microphone, which captures audio, or other audio input.

The computer system (900) optionally includes a video output (960), which provides video output to a display device. The video output (960) can be an HDMI output or other type of output. An optional audio output (960) provides audio output to one or more speakers.

The storage (970) may be removable or non-removable, and includes magnetic media (such as magnetic disks, magnetic tapes or cassettes), optical disk media and/or any other media which can be used to store information, and which can be accessed within the computer system (900). The storage (970) stores instructions for the software (980) implementing aspects of the innovations for implementing cross-platform neural codecs using transmitted entropy distribution parameters.

The computer system (900) may have additional aspects. For example, the computer system (900) includes one or more other input devices and/or one or more other output devices. The other input device(s) may be a touch input device such as a keyboard, mouse, pen, or trackball, a scanning device, or another device that provides input to the computer system (900). The other output device(s) may be a printer, CD-writer, or another device that provides output from the computer system (900).

An interconnection mechanism (not shown) such as a bus, controller, or network interconnects the components of the computer system (900). Typically, operating system software (not shown) provides an operating environment for other software executing in the computer system (900), and coordinates activities of the components of the computer system (900).

The computer system (900) of FIG. 9 is a physical computer system. A virtual machine can include components organized as shown in FIG. 9.

The term “application” or “program” refers to software such as any user-mode instructions to provide functionality. The software of the application (or program) can further include instructions for an operating system and/or device drivers. The software can be stored in associated memory. The software may be, for example, firmware. While it is contemplated that an appropriately programmed general-purpose computer or computing device may be used to execute such software, it is also contemplated that hard-wired circuitry or custom hardware (e.g., an ASIC) may be used in place of, or in combination with, software instructions. Thus, examples described herein are not limited to any specific combination of hardware and software.

The term “computer-readable medium” refers to any medium that participates in providing data (e.g., instructions) that may be read by a processor and accessed within a computing environment. A computer-readable medium may take many forms, including non-volatile media and volatile media. Non-volatile media include, for example, optical or magnetic disks and other persistent memory. Volatile media include dynamic random-access memory (“DRAM”). Common forms of computer-readable media include, for example, a solid-state drive, a flash drive, a hard disk, any other magnetic medium, a CD-ROM, DVD, any other optical medium, RAM, programmable read-only memory (“PROM”), erasable programmable read-only memory (“EPROM”), a USB memory stick, any other memory chip or cartridge, or any other medium from which a computer can read. The term “non-transitory computer-readable media” specifically excludes transitory propagating signals, carrier waves, and wave forms or other intangible or transitory media that may nevertheless be readable by a computer. The term “carrier wave” may refer to an electromagnetic wave modulated in amplitude or frequency to convey a signal.

The innovations can be described in the general context of computer-executable instructions being executed in a computer system on a target real or virtual processor. The computer-executable instructions can include instructions executable on processing cores of a general-purpose processor to provide functionality described herein, instructions executable to control a GPU, NPU, or special-purpose hardware to provide functionality described herein, instructions executable on processing cores of a GPU or NPU to provide functionality described herein, and/or instructions executable on processing cores of a special-purpose processor to provide functionality described herein. In some implementations, computer-executable instructions can be organized in program modules. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computer system.

The terms “system” and “device” are used interchangeably herein. Unless the context clearly indicates otherwise, neither term implies any limitation on a type of computer system or device. In general, a computer system or device can be local or distributed, and a computer system can include any combination of special-purpose hardware and/or hardware with software implementing the functionality described herein.

Numerous examples are described in this disclosure and are presented for illustrative purposes only. The described examples are not, and are not intended to be, limiting in any sense. The presently disclosed innovations are widely applicable to numerous contexts, as is readily apparent from the disclosure. One of ordinary skill in the art will recognize that the disclosed innovations may be practiced with various modifications and alterations, such as structural, logical, software, and electrical modifications. Although particular aspects of the disclosed innovations may be described with reference to one or more particular examples, it should be understood that such aspects are not limited to usage in the one or more particular examples with reference to which they are described, unless expressly specified otherwise. The present disclosure is neither a literal description of all examples nor a listing of aspects of the disclosed technology that must be present in all examples.

When an ordinal number (such as “first,” “second,” “third” and so on) is used as an adjective before a term, that ordinal number is used (unless expressly specified otherwise) merely to indicate a particular instance, such as to distinguish that particular instance from another instance that is described by the same term or by a similar term. The mere usage of the ordinal numbers “first,” “second,” “third,” and so on does not indicate any physical order or location, any ordering in time, or any ranking in importance, quality, or otherwise. In addition, the mere usage of ordinal numbers does not define a numerical limit to the instances identified with the ordinal numbers.

When introducing elements, the articles “a,” “an,” “the,” and “said” are intended to mean that there are one or more of the elements. The terms “comprising,” “including,” and “having” are intended to be inclusive and mean that there may be additional elements other than the listed elements.

When a single device, component, module, or structure is described, multiple devices, components, modules, or structures (whether or not they cooperate) may instead be used in place of the single device, component, module, or structure. Functionality that is described as being possessed by a single device may instead be possessed by multiple devices, whether or not they cooperate. Similarly, where multiple devices, components, modules, or structures are described herein, whether or not they cooperate, a single device, component, module, or structure may instead be used in place of the multiple devices, components, modules, or structures. Functionality that is described as being possessed by multiple devices may instead be possessed by a single device. In general, a computer system or device can be local or distributed, and a computer system can include any combination of special-purpose hardware and/or hardware with software implementing the functionality described herein.

The respective techniques and tools described herein may be utilized independently and separately from other techniques and tools described herein.

Device, components, modules, or structures that are in communication with each other need not be in continuous communication with each other, unless expressly specified otherwise. On the contrary, such devices, components, modules, or structures need only transmit to each other as necessary or desirable, and in some situations, they may actually refrain from exchanging data most of the time. For example, a device in communication with another device via the Internet might not transmit data to the other device for weeks at a time. In addition, devices, components, modules, or structures that are in communication with each other may communicate directly or indirectly through one or more intermediaries.

As used herein, the term “send” denotes any way of conveying information from one device, component, module, or structure to another device, component, module, or structure. The term “receive” denotes any way of getting information at one device, component, module, or structure from another device, component, module, or structure. The devices, components, modules, or structures can be part of the same computer system or different computer systems. Information can be passed by value (e.g., as a parameter of a message or function call) or passed by reference (e.g., in a buffer). Depending on context, information can be communicated directly or be conveyed through one or more intermediate devices, components, modules, or structures. As used herein, the term “connected” denotes an operable communication link between devices, components, modules, or structures, which can be part of the same computer system or different computer systems. The operable communication link can be a wired or wireless network connection, which can be direct or pass through one or more intermediaries (e.g., of a network).

As used herein, the term “set,” when used as a noun to indicate a group of elements, indicates a non-empty group, unless context clearly indicates otherwise. That is, the “set” has one or more elements, unless context clearly indicates otherwise.

In the examples described herein, identical reference numbers in different figures indicate an identical component, module, or operation. Depending on context, a given component or module may accept a different type of information as input and/or produce a different type of information as output, or be processed in a different way.

More generally, various alternatives to the examples described herein are possible. For example, some of the methods described herein can be altered by changing the ordering of the method acts described, by splitting, repeating, or omitting certain method acts, etc. The various aspects of the disclosed technology can be used in combination or separately. Different embodiments use one or more of the described innovations. Some of the innovations described herein address one or more of the problems noted in the background. Typically, a given technique/tool does not solve all such problems

As used herein, the term “based on” or “based at least in part on” indicates a dependence. A value or output X that is “based on” (or “based at least in part on”) a value or input Y depends on Y but can also depend on additional information or factors. Y can be directly or indirectly used when determining, assigning, generating, calculating, or creating X “based on” (or “based at least in part on”) Y. Thus, for example, the language determining or assigning X “based on” Y can indicate determining or assigning X using Y.

A description of an example with several aspects does not imply that all or even any of such aspects are required. On the contrary, a variety of optional aspects are described to illustrate the wide variety of possible examples of the innovations described herein. Unless otherwise specified explicitly, no aspect is essential or required.

Further, although process steps and stages may be described in a sequential order, such processes may be configured to work in different orders. Description of a specific sequence or order does not necessarily indicate a requirement that the steps or stages be performed in that order. Steps or stages may be performed in any order practical. Further, some steps or stages may be performed simultaneously despite being described or implied as occurring non-simultaneously. Description of a process as including multiple steps or stages does not imply that all, or even any, of the steps or stages are essential or required. Various other examples may omit some or all of the described steps or stages. Unless otherwise specified explicitly, no step or stage is essential or required. Similarly, although a product may be described as including multiple aspects, qualities, or characteristics, that does not mean that all of them are essential or required. Various other examples may omit some or all of the aspects, qualities, or characteristics.

An enumerated list of items does not imply that any or all of the items are mutually exclusive, unless expressly specified otherwise. Likewise, an enumerated list of items does not imply that any or all of the items are comprehensive of any category, unless expressly specified otherwise.

For the sake of presentation, the detailed description uses terms like “determine” and “select” to describe computer operations in a computer system. These terms denote operations performed by one or more processors or other components in the computer system, and these terms should not be confused with acts performed by a human being. The actual computer operations corresponding to these terms vary depending on implementation.

In the examples described herein, identical reference numbers in different figures indicate an identical component, module, or operation. More generally, various alternatives to the examples described herein are possible. For example, some of the methods described herein can be altered by changing the ordering of the method acts described, by splitting, repeating, or omitting certain method acts, etc. The various aspects of the disclosed technology can be used in combination or separately. Some of the innovations described herein address one or more of the problems noted in the background. Typically, a given technique or tool does not solve all such problems. It is to be understood that other examples may be utilized and that structural, logical, software, hardware, and electrical changes may be made without departing from the scope of the disclosure.

In view of the many possible embodiments to which the principles of the disclosed subject matter may be applied, it should be recognized that the illustrated embodiments are only preferred examples and should not be taken as limiting the scope of the claims. Rather, the scope of the invention is defined by the following claims. We therefore claim as our invention all that comes within the scope of these claims.

What is claimed is:

1. A method of decoding digital media having encoded latents, the method comprising:
with a processor:
producing, from the digital media, entropy distribution parameters for decoding the digital media using an adaptive entropy model, at least one of the entropy distribution parameters having been losslessly encoded in the digital media; and
decoding the encoded latents from the digital media using at least one of the losslessly encoded entropy distribution parameters.

2. The method of claim 1, wherein:
the adaptive entropy model comprises an entropy distribution modeled as an adaptive Gaussian distribution having mean and scale parameters; and
at least one of the entropy distribution parameters comprises a scale parameter.

3. The method of claim 2, wherein the scale parameter is used to decode a first latent and a second, different latent from the digital media.

4. The method of claim 1, wherein:
the digital media comprises a first bitstream comprising the losslessly encoded entropy distribution parameters; and
the digital media comprises a second bitstream comprising the encoded latents.

5. The method of claim 1, further comprising:
producing predicted entropy distribution parameters from hyperlatents encoded in the digital media; and
the decoding the encoded latents from the digital media further comprises using at least one of the predicted entropy distribution parameters.

6. The method of claim 5, further comprising:
storing the hyperlatents in a computer-readable storage media or transmitting the hyperlatents via a computer network.

7. The method of claim 1, wherein at least one of the losslessly encoded entropy distribution parameters is an index for a set of predefined discrete probability distributions, wherein the index is used to decode at least one value encoded in the digital media using the adaptive entropy model.

8. The method of claim 7, wherein the set of predefined discrete probability distributions comprises at least one discretized Gaussian distributions having a scale parameter, further comprising:
producing the scale parameter using the index for a set of predefined discrete probability distributions encoded in the digital media; or
producing the scale parameter using a predetermined mathematical formula from data encoded in the digital media.

9. The method of claim 1, wherein the adaptive entropy model comprises an entropy distribution modeled as an adaptive Gaussian distribution having mean parameters and scale parameters, the method further comprising:
decoding hyperlatents from the digital media;
producing combined quantized latents for reconstructing images or video based on the decoded latents; and
producing at least one of the scale parameters by slicing and expanding the decoded hyperlatents, at least one of the scale parameters being shared by at least two latents encoded in the digital media.

10. The method of claim 9, further comprising producing the mean parameters by:
producing first mean values from the decoded hyperlatents using a first machine learning model,
producing first quantized latents by shifting the decoded latents according to the first mean values,
producing second mean values from the first mean values using a second neural network,
producing second quantized latents by shifting the decoded latent values according to the second mean values, and
the decoding the latents comprises producing combined quantized latents using the first quantized latents and the second quantized latents.

11. The method of claim 9, wherein:
the decoding the latents or the decoding the hyperlatents is performed using a decoder neural network, wherein the scale parameters used to encode the digital media are determined after training the decoder neural network.

12. The method of claim 9, wherein:
the latents and hyperlatents are represented in a floating-point format and the encoded latents and hyperlatents are represented in an integer format;
the digital media comprises encoded individual images, video, or individual images and video; and
the hyperlatents comprise scale parameters used to entropy encode the latents.

13. The method of claim 1, wherein the digital media is received via a computer network, the digital media comprises digital images, video, or digital images and video, the method further comprising:
using the decoded latents, reconstructing the digital images, video, or digital images and video; and
displaying the digital images, video, or digital images and video using a display.

14. The method of claim 1, further comprising:
generating the latents by encoding the digital media using a neural network encoder;
generating the entropy distribution parameters using and adaptive entropy model;
encoding the latents and the entropy distribution parameters in the digital media; and
sending the latents and the entropy distribution parameters via a computer-readable media,
wherein a first system comprising a processor used to perform the encoding the digital media produces different entropy distribution parameters than a second system comprising the processor decoding the digital media due to differences in a representation of the latents, hyperlatents, or entropy distribution parameters between the first system and the second system.

15. The method of claim 14, wherein the digital media comprises video, the method further comprising:
extracting a feature from a first frame of the video and producing context based on the extracted feature; and
encoding the digital media by encoding a second frame of the video using the context, wherein a parameter used to entropy encode the digital media is based on the produced context.

16. Computer-readable storage media storing computer-executable instructions, which when executed by a processor, cause the processor to perform a method of decoding images or video with a machine learning tool, the instructions comprising:
instructions that cause the processor to produce a scale value from a received hyperlatent for decoding a latent tensor from a bitstream;
instructions that cause the processor to, with a machine learning tool, generate a predicted mean value from the received hyperlatent; and
instructions that cause the processor to decode the latent tensor based on the produced scale value and the mean value, the scale value being used to determine at least two elements of a decoded quantized latent.

17. The computer-readable storage media of claim 16, wherein the computer-executable instructions further comprise:
instructions that cause the processor to generate the predicted mean value by producing a first mean value from the received hyperlatent, shifting at least one entropy-decoded latent, and producing second means values from the first mean values and the at least one shifted entropy-decoded latent.

18. The computer-readable storage media of claim 16, wherein:
the instructions further comprise instructions that cause the processor to perform a method of encoding the images or video;
at least some of the computer-executable instructions or for a different type of processor than the processor or a different type of machine learning model than the machine learning model used to encode the video; and/or
the processor is a graphics processing unit or a neural processing unit.

19. A system comprising:
the computer-readable storage media of claim 16;
the processor, wherein the processor is a graphics processing unit or a neural processing unit configured to execute the computer-executable instructions;
a network interface configured to receive a bitstream comprising the hyperlatents via a computer-readable media or a computer-readable storage media; and
a display interface to cause a display to display video or images encoded in the received bitstream.

20. A method of training neural networks for encoding video, the method comprising:
selecting a loss function to achieve desired characteristics of a neural encoder/decoder system comprising at least one neural network;
successively encoding and decoding images from a training set applied to the neural encoder/decoder system;
comparing reconstructed frames generated by the encoder/decoder system to images from the training set to evaluate the loss function;
adjusting parameters of the at least one neural network to converge the neural networks; and
storing weights or activation values for the trained neural networks in a computer-readable storage medium.
